(19) United States
(12) Patent Application Publication
(10) Pub. No.: US 2011/0123432 A1
(43) Pub. Date: May 26, 2011

(54) HYDRATE FORMATION FOR GAS SEPARATION OR TRANSPORT

(75) Inventor: John J. Waycuilis, Cypress, TX (US)

(73) Assignee: Marathon Oil Company, Houston, TX (US)

(21) Appl. No.: 13/023,472

(22) Filed: Feb. 8, 2011

Related U.S. Application Data
(62) Division of application No. 11/904,307, filed on Sep. 25, 2007.
Application No. 11/904,307 is a continuation-in-part of application No. 10/718,249, filed on Nov. 19, 2003, now Pat. No. 7,511,180.
Application No. 10/718,249 is a continuation-in-part of application No. 09/877,798, filed on Jun. 8, 2001, now Pat. No. 6,703,534.
Application No. 09/877,798 is a continuation-in-part of application No. 09/476,297, filed on Dec. 30, 1999, now Pat. No. 6,350,928.

(51) Int. Cl. C01B 3/52; B01D 9/04

(52) U.S. Cl. 423/648.1; 62/532

(57) ABSTRACT

A gas separation or gas transportation process forms a gas hydrate from an aqueous feed and a gas feed having a hydrate P-T stability envelope. While in the presence of the aqueous feed, the gas feed is initially pressurized to an operating pressure and cooled to an operating temperature which are inside the hydrate P-T stability envelope to form a gas hydrate from at least a portion of the gas feed and at least a portion of the aqueous feed. The resulting gas hydrate is readily separable from any remaining gas and stable for transport.

This is a divisional of copending Ser. No. 11/904,307 filed on Sep. 25, 2007, which is a continuation-in-part of Ser. No. 10/718,249 filed on Nov. 19, 2003 and issued as U.S. Pat. No. 7,511,180 on Mar. 31, 2009, which is a continuation-in-part of Ser. No. 09/877,798 filed on Jun. 8, 2001 and issued as U.S. Pat. No. 6,703,534 on Mar. 9, 2004, which is a continuation-in-part of Ser. No. 09/476,297 filed on Dec. 30, 1999 and issued as U.S. Pat. No. 6,350,928 on Feb. 26, 2002. All of the above-listed patents and patent applications are incorporated herein by reference.

### TECHNICAL FIELD

The present invention relates generally to gas hydrate formation processes which facilitate separation of gases in a mixture or the transportation of a gas and, more particularly, to process for forming gas hydrates in a fluidized bed heat exchanger.

### BACKGROUND OF THE INVENTION

There are many hydrocarbon processing applications where it is desirable to separate higher molecular weight gases from lower molecular weight gases within a gas mixture. For example, it is common to process natural gas by separating hydrogen sulfide, carbon dioxide and/or propane from methane in the natural gas. It is likewise common to process a synthesis gas by separating carbon dioxide from more desirable hydrogen and carbon monoxide in the synthesis gas.

Processes for separating a higher molecular weight gas component from a gas mixture containing a lower molecular weight gas component and the higher molecular weight gas component often exploit differences between the boiling points and condensing temperatures of the gas components. These processes effect separation by cryogenic liquid distillation. Alternatively, if one of the gas components of the gas mixture is a polar or ionizing component, such as carbon dioxide or hydrogen sulfide which readily reacts with aqueous solutions of alkaline chemicals, such as a monoethanolamine or like compounds, separation of the polar or ionizing gas component is commonly effected by solvent absorption.

Both of the above-recited separation mechanisms are capable of a high degree of separation, but require a significant amount of energy input. For example, cryogenic liquid distillation requires significant refrigeration power to liquify the gas mixture, while solvent absorption requires significant process heat for the solvent regeneration and stripping step.

Membrane separation processes, which employ semi-permeable membranes, are typically more energy-efficient than cryogenic liquid distillation or solvent absorption processes. However, the permeation rates for most gas components through currently available polymeric membranes are relatively low. Accordingly, very large membrane surface areas are required to achieve a degree of separation comparable to the above-recited processes. As a result, membrane separation processes typically involve relatively high capital costs. Furthermore, the selectivity of membranes is often relatively poor, resulting in high losses of the more desirable gas component to the reject stream.

The present invention both recognizes and satisfies a need for an alternate relatively energy-efficient, low-cost, highly-effective gas separation process using gas hydrate formation as described hereafter.

An alternate application of the present invention is for the transportation of gas streams such as natural gas from locations which are remote from pipeline markets such as offshore gas fields. One potential solution to the difficulties inherent in transporting a remote natural gas stream is to convert the gas stream to a liquified natural gas (LNG) at or near the gas field where the natural gas is produced in preparation for transport. The natural gas is much more readily transportable in a liquid form. However, the equipment and energy costs for an on-site LNG conversion facility are often impractical. The present invention both recognizes and satisfies a need for an alternate relatively energy-efficient, low-cost, highly-effective gas transportation process using gas hydrate formation as described hereafter.

### SUMMARY OF THE INVENTION

The present invention is a gas separation process for a gas mixture feed which includes a first gas having a first hydrate P-T stability envelope and a second gas having a second hydrate P-T stability envelope different from the first hydrate P-T stability envelope. The gas mixture feed is pressurized to an operating pressure and cooled to an operating temperature. The operating pressure and operating temperature are outside the first hydrate P-T stability envelope and inside the second hydrate P-T stability envelope. The second gas is contacted with a water at the operating pressure and operating temperature to form a gas hydrate from at least a portion of the second gas and at least a portion of the water. The gas hydrate is separated from the first gas and placed in heat transfer communication with the gas mixture feed to decompose the gas hydrate. In accordance with a preferred embodiment, the gas hydrate absorbs the latent heat of hydrate formation.

In one alternative, the first gas is a lighter gas and the second gas is a heavier gas. In another alternative, the first gas is a pure first gas component and the first hydrate P-T stability envelope is a pure first component hydrate P-T stability envelope. Likewise or alternatively, the second gas is a pure second gas component and the second hydrate P-T stability envelope is a pure second component hydrate P-T stability envelope. An exemplary preferred pure first gas component is hydrogen or methane and an exemplary preferred pure second gas component is carbon dioxide.

In another alternative, the first gas is a gas component mixture including two or more pure gas components and the first hydrate P-T stability envelope is a component mixture hydrate P-T stability envelope. Likewise or alternatively, the second gas is a gas component mixture including two or more pure gas components and the second hydrate P-T stability envelope is a component mixture hydrate P-T stability envelope.

The present invention is further characterized as an alternate gas separation process for the above-recited gas mixture feed. The gas mixture feed and an aqueous liquid feed are included within a fluidizable mixture. A solid particle medium, which is preferably essentially inert in the presence of the fluidizable mixture, is entrained in the fluidizable mixture to form a fluidized mixture. The fluidized mixture is conveyed past a heat transfer surface while contacting the fluidized mixture with the heat transfer surface. The heat transfer surface is cooler than the fluidized mixture, thereby cooling the fluidized mixture at an operating pressure upon contact with the heat transfer surface to a temperature below an operating temperature. The operating pressure and operating temperature are outside the first hydrate P-T stability envelope of the first gas in the gas mixture feed and inside the second hydrate P-T stability envelope of the second gas in the gas mixture feed. Accordingly, at least a portion of the second gas and at least a portion of the aqueous liquid feed are converted to a plurality of gas hydrate particles. A gas hydrate slurry is formed which comprises the plurality of gas hydrate particles and a portion of the aqueous liquid feed and the resulting gas hydrate slurry is separated from the first gas.

The first gas can be recovered to provide a first recovered quantity of the first gas. In accordance with one embodiment, the first recovered quantity of the first gas is a purified gas product. In accordance with another embodiment, the first recovered quantity is combined in a second gas mixture feed with an unreacted portion of the second gas from the first gas mixture feed and the process steps recited above with respect to the first gas mixture feed are repeated with respect to the second gas mixture feed. The first gas separated from the gas hydrate slurry in the repeating steps provides a second recovered quantity of the first gas which is more concentrated than the first recovered quantity. In accordance with one embodiment, the second recovered quantity of the first gas is a purified gas product.

The gas separation process can further comprise heating the gas hydrate slurry after separating the gas hydrate slurry from the first gas to decompose the gas hydrate particles and produce a decomposition quantity of the second gas and the portion of the aqueous liquid feed. In accordance with one embodiment, the gas hydrate slurry is heated by placing it in heat transfer communication with the fluidized mixture, causing the gas hydrate slurry to absorb the latent heat of hydrate formation from the fluidized mixture and decomposing the gas hydrate particles in the gas hydrate slurry.

In another characterization, the present invention is a gas transportation process. A fluidizable mixture is provided at a gas loading location. The fluidizable mixture comprises an aqueous liquid feed and a hydrocarbon fluid feed including a hydrocarbon liquid and a hydrocarbon gas which has a hydrate P-T stability envelope. A solid particle medium is entrained in the fluidizable mixture to form a fluidized mixture. The fluidized mixture is conveyed past a heat transfer surface while contacting the fluidized mixture with the heat transfer surface. The heat transfer surface is cooler than the fluidized mixture, thereby cooling the fluidized mixture at an operating pressure upon contact with the heat transfer surface to an operating temperature. The operating pressure and operating temperature are inside the hydrate P-T stability envelope of the hydrocarbon gas.

At least a portion of the hydrocarbon gas and at least a portion of the aqueous liquid feed are converted to a plurality of gas hydrate particles. A gas hydrate slurry is formed which comprises the plurality of gas hydrate particles and at least a portion of the hydrocarbon liquid. The gas hydrate slurry is transported to a gas off-loading location and heated at the gas off-loading location to decompose the gas hydrate slurry to an aqueous liquid, the hydrocarbon liquid and the hydrocarbon gas. The aqueous liquid, hydrocarbon liquid and hydrocarbon gas are then separated from one another.

In accordance with one embodiment, the gas separation process further comprises conveying the gas hydrate slurry past a second heat transfer surface at the gas loading location while contacting the gas hydrate slurry with the second heat transfer surface. The second heat transfer surface is cooler than the gas hydrate slurry, thereby subcooling the gas hydrate slurry to a subcooled temperature upon contact with the second heat transfer surface. The subcooled gas hydrate slurry can be depressurized before transporting to the gas off-loading location.

In accordance with another embodiment, the hydrocarbon liquid produced from the decomposition of the gas hydrate slurry is separated from the hydrocarbon gas in a high pressure separator. The hydrocarbon liquid separated from the hydrocarbon gas can be conveyed to a low pressure separator and depressurized therein to produce additional hydrocarbon gas.

The present invention will be further understood from the drawings and the following detailed description. Although this description sets forth specific details, it is understood that certain embodiments of the invention may be practiced without these specific details. It is also understood that in some instances, well-known processing equipment, operations, and techniques have not been shown in detail in order to avoid obscuring the understanding of the invention.

### BRIEF DESCRIPTION OF THE DRAWINGS

FIG. 1 is a schematic view of process equipment configured in a separation system to practice an embodiment of a gas separation process of the present invention.

FIG. 2 is a conceptualized cross-sectional view of a fluidized bed heat exchanger having utility in the embodiment of FIG. 1.

FIG. 3 is a graphical representation of hydrate P-T stability envelopes for several common pure gas components.

FIG. 4 is a graphical representation of hydrate P-T stability envelopes for the pure gas component methane, for the pure gas component carbon dioxide and for two-component gas mixtures of carbon dioxide and methane.

FIG. 5 is a graphical representation of hydrate P-T stability envelopes for the pure gas component carbon dioxide and for two-component gas mixtures of carbon dioxide and hydrogen.

FIG. 6 is a schematic view of process equipment configured in an alternate separation system to practice an alternate embodiment of a gas separation process of the present invention.

FIG. 7 is a conceptualized cross-sectional view of an alternate fluidized bed heat exchanger having utility in the embodiment of FIG. 6.

FIG. 8 is a schematic view of process equipment configured in a gas hydrate formation system to practice an embodiment of a gas transportation process of the present invention.

FIG. 9 is a schematic view of process equipment configured in a gas hydrate decomposition system to practice an embodiment of a gas transportation process of the present invention.

Embodiments of the invention are illustrated by way of example and not by way of limitation in the above-recited figures of the drawings in which like reference numbers indicate the same or similar elements. It should be noted that common references to “an embodiment”, “one embodiment”, “an alternate embodiment”, “a preferred embodiment”, or the like herein are not necessarily references to the same embodiment.

### DESCRIPTION OF PREFERRED EMBODIMENTS

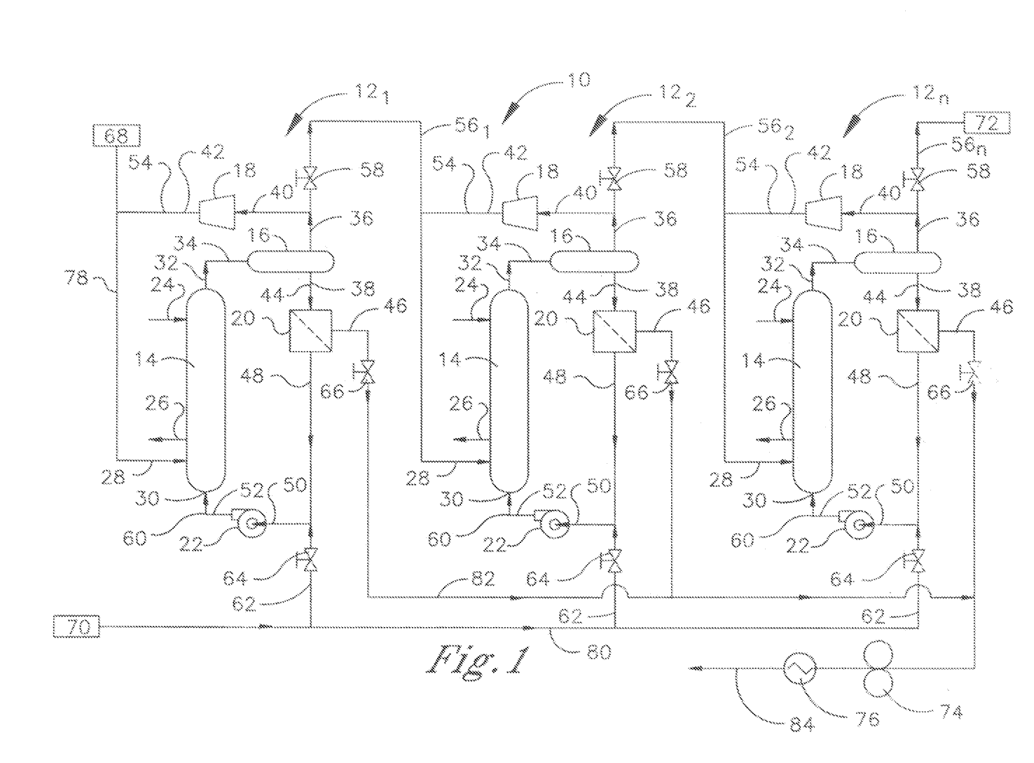

Referring to FIG. 1, a schematic flow diagram of a separation system generally designated 10 is shown, which has utility in the practice of an embodiment of a gas separation process of the present invention. The system 10 includes a plurality of sequential separation stages operating in series. Each separation stage is designated by the reference number 12 followed by a numeric subscript, which is specific to the particular position of that separation stage within the system 10. Thus, the first separation stage of the system 10 is designated by the reference number 12₁, the second separation stage is designated by the reference number 12₂, and so on. The final separation stage of the system 10 is termed the nth separation stage and is designated by the reference number 12ₙ.

Separation systems having utility in the practice of the present gas separation process are not limited to systems having any specific number of separation stages. The skilled practitioner selects the number of separation stages for the particular separation system as a function of the inlet concentrations of gas components within a gas mixture feed, the required purity level of the purified gas product, and/or the recovery efficiency required. It is believed that for most practical applications a separation system having either three or four separation stages in series is sufficient to effectively practice the present gas separation process. Nevertheless, it is also within the scope of the present invention to effectively practice the present gas separation process using a separation system which has only a single separation stage, which has two separation stages, or which has five or more separation stages.

Each separation stage 12₁, 12₂, 12ₙ of the separation system 10 is preferably essentially the same as the other separation stages. Accordingly, all of the separation stages 12₁, 12₂, 12ₙ are initially described hereafter with reference to a single common separation stage 12. The separation stage 12 comprises a hydrate-forming heat exchanger 14, a gas separator 16, a gas recycler 18, a slurry concentrator 20, and a liquid pressurizer 22. The heat exchanger 14 has a heat transfer medium inlet 24, a heat transfer medium outlet 26, a gas feed inlet 28, a liquid feed inlet 30, and a multi-phase outlet 32. The gas separator 16 has a multi-phase inlet 34, a gas outlet 36, and a slurry outlet 38. The gas recycler 18 has a gas inlet 40 and a gas outlet 42. The slurry concentrator 20 has a slurry inlet 44, a slurry outlet 46, and a liquid outlet 48. The liquid pressurizer 22 has a liquid inlet 50 and a liquid outlet 52.

The gas outlet 36 of the gas separator 16 splits into a gas recycle line 54 and a gas outlet line 56. The gas recycler 18 is positioned in the gas recycle line 54 and a gas flow control valve 58 is positioned in the gas outlet line 56. A liquid recycle line 60 extends from the liquid outlet 48 of the slurry concentrator 20 to the liquid feed inlet 30 of the heat exchanger 14. The liquid pressurizer 22 is positioned in the liquid recycle line 60. A make-up liquid inlet 62 ties into the liquid recycle line 60 upstream of the liquid pressurizer 22 and a liquid flow control valve 64 is positioned in the make-up liquid inlet 62. A slurry flow control valve 66 is positioned in the slurry outlet 46 of the slurry concentrator 20.

The gas recycler 18 is essentially any device or other means known to the skilled artisan which is capable of inducing a flow of a gas composition or a gas/liquid composition through the gas recycle line 54 into the gas feed inlet 28 of the heat exchanger 14 and through the heat exchanger 14 as described hereafter. As such, an exemplary gas recycler having utility herein is a compressor, a blower, a multiphase pump, a gas- or liquid-powered venturi-eductor or the like. The slurry concentrator 20 is essentially any device or other means known to the skilled artisan which is capable of separating a portion of a liquid from a slurry to increase the solids concentration of the slurry. As such, an exemplary slurry concentrator having utility herein is a simple gravity filtration column, a hydrocyclone filtration device or the like. The liquid pressurizer 22 is essentially any device or other means known to the skilled artisan which is capable of pressurizing the liquid composition fed through the liquid recycle line 60 into the liquid feed inlet 30 of the heat exchanger 14 and through the heat exchanger 14 as described hereafter. As such, an exemplary liquid pressurizer having utility herein is a liquid pump or the like.

The separation system 10 further includes a gas mixture feed source 68, a make-up liquid source 70, a purified gas product receiver 72, a slurry pump 74 and a hydrate decomposer 76. A gas mixture feed line 78 is provided which couples the gas mixture feed source 68 to the gas feed inlet 28 of the heat exchanger 14 in the first separation stage 12₁. The outlet end of the gas recycle line 54 ties into the gas mixture feed line 78.

The separation stages 12₁, 12₂, 12ₙ of the separation system 10 are coupled in series to one another by the gas outlet lines 56₁, 56₂. In particular, serial communication between the first and second separation stages 12₁, 12₂ is provided by the gas outlet line 56₁ which extends from the gas outlet 36 of the gas separator 16 in the first separation stage 12₁ to the gas feed inlet 28 of the heat exchanger 14 in the second separation stage 12₂. Serial communication between the second separation stage 12₂ and the nth separation stage 12ₙ (the third separation stage in the present embodiment) is similarly provided by the gas outlet line 56₂ which extends from the gas outlet 36 of the gas separator 16 in the second separation stage 12₂ to the gas feed inlet 28 of the heat exchanger 14 in the nth separation stage 12₃. The gas outlet line 56ₙ extends from the gas outlet 36 of the gas separator 16 in the nth separation stage 12ₙ to the purified gas product receiver 72.

The separation stages 12₁, 12₂, 12ₙ of the separation system 10 are coupled in parallel by a make-up liquid line 80. In particular, the make-up liquid line 80 ties into each of the separation stages 12₁, 12₂, 12ₙ by coupling to the respective make-up liquid inlet 62 for each separation stage 12₁, 12₂, 12ₙ. The inlet end of the make-up liquid line 80 is further coupled to the make-up liquid source 70, thereby providing a conduit from the make-up liquid source 70 to each of the separation stages 12₁, 12₂, 12ₙ. The separation stages 12₁, 12₂, 12ₙ are also coupled in parallel by a hydrate collection line 82. In particular, the hydrate collection line 82 ties into each of the separation stages 12₁, 12₂, 12ₙ by coupling to the respective slurry outlet 46 of the slurry concentrator 20 for each separation stage 12₁, 12₂, 12ₙ. The outlet end of the hydrate collection line 82 is further coupled to a system discharge outlet 84, thereby providing a conduit from each of the separation stages 12₁, 12₂, 12ₙ to the system discharge outlet 84. The slurry pump 74 and the hydrate decomposer 76 are serially positioned in the hydrate collection line 82 downstream of the final nth separation stage 12ₙ (the third separation stage in the present embodiment).

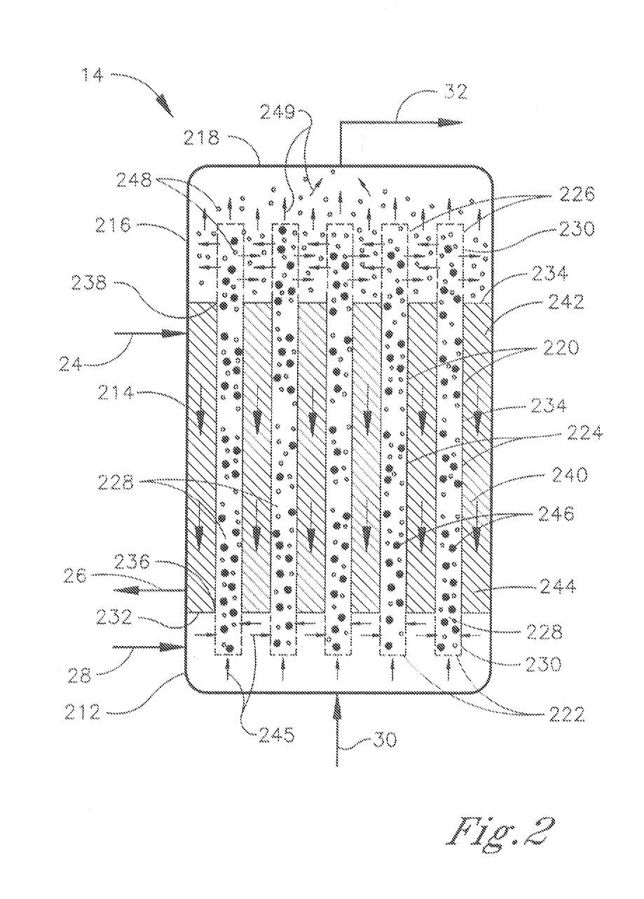

A particular type of hydrate-forming heat exchanger 14 having utility in each of the separation stages 12₁, 12₂, 12ₙ is shown and described with additional reference to FIG. 2. The heat exchanger 14 of FIG. 2 is termed a fluidized bed heat exchanger (FBHX). It is understood that the FBHX 14 is shown by way of example rather than by way of limitation. Other alternately configured FBHX's can be adapted by the skilled artisan for utility herein such as those disclosed in commonly-owned U.S. Pat. No. 6,350,928 incorporated herein by reference.

The FBHX 14 is functionally partitioned into a plurality of vertically stratified, serial chambers, namely, a lower chamber 212, a middle chamber 214, and an upper chamber 216. The lower chamber 212 is functionally defined as a mixing zone, the middle chamber 214 is functionally defined as a heat transfer zone, and the upper chamber 216 is functionally defined as a separation zone. The lower, middle, and upper chambers 212, 214, 216 are enclosed by a shell 218 which is a continuous vessel surrounding the FBHX 14.

The gas feed inlet 28 and the liquid feed inlet 30 access the lower chamber 212 through the shell 218. A plurality of substantially parallel riser tubes 220 are vertically disposed within the shell 218, extending from the lower chamber 212, through the middle chamber 214 and into the upper chamber 216. As such, each riser tube 220 has a lower end 222 positioned in the lower chamber 212, a middle segment 224 positioned in the middle chamber 214, and an upper end 226 positioned in the upper chamber 216. The upper end 226 is preferably substantially longer than the lower end 222. However, both the lower and upper ends 222, 226 are mutually characterized as porous, thereby providing fluid communication between the tube interiors 228 and the lower and upper chambers 212, 216, respectively, external to the riser tubes 220.

Thus, gases and liquids are able to pass freely from the portions of the lower and upper chambers 212, 216 external to the riser tubes 220, through the lower and upper ends 222, 226, respectively, and into the tube interiors 228 or vice versa.

The porous character of the tubular lower and upper ends 222, 226 can be achieved by fabricating them from screens or other such porous material or, alternatively, by fabricating the tubular lower and upper ends 222, 226 from a non-porous material, but providing holes, gaps, perforations or other such openings in the non-porous material. In the present embodiment, the lower and upper ends 222, 226 are provided with a plurality of openings 230, which render them porous.

A lower tube plate 232 is positioned at the junction of the lower and middle chambers 212, 214 and an upper tube plate 234 is correspondingly positioned at the junction of the middle and upper chambers 214, 216. The lower and upper tube plates 232, 234 are aligned essentially parallel to one another and essentially perpendicular to the riser tubes 220 passing therethrough. The middle segment 224 of each riser tube 220 extends the length of the middle chamber 214, engaging the lower tube plate 232 at a lower plate/tube interface 236 and engaging the upper tube plate 234 at an upper plate/tube interface 238.

The riser tubes 220 are spatially separated from one another to provide an open interstitial space 240 between and around the riser tubes 220 within the middle chamber 214. The middle segment 224 of each riser tube 220 has a continuous, essentially fluid-impervious wall which essentially prevents fluid communication between the interstitial space 240 and the tube interiors 228. The lower and upper tube plates 232, 234 support the riser tubes 220 and maintain them in their fixed positions relative to one another. The upper and lower plate/tube interfaces 236, 238 are effective fluid seals which essentially prevent fluid communication between the interstitial space 240 and the portions of the lower and upper chambers 212, 216, respectively, which are external to the riser tubes 220. It is noted, however, that the lower and upper tube plates 232, 234 do not penetrate or otherwise block the tube interiors 228 to impede flow therethrough.

The heat transfer medium inlet 24 and the heat transfer medium outlet 26 access the open interstitial space 240 of the middle chamber 214 through the shell 218. In particular, the heat transfer medium inlet 24 accesses the interstitial space 240 in an upper portion 242 of the middle chamber 214 and the heat transfer medium outlet 26 accesses the interstitial space 240 in a lower portion 244 of the middle chamber 214. The open interstitial space 240 defines a heat transfer medium flow path through the FBHX 14 which extends essentially the entire length of the middle chamber 214 from the heat transfer medium inlet 24 to the heat transfer medium outlet 26.

The open tube interiors 228 of the riser tubes 220 similarly define a fluidizable mixture flow path through the FBHX 14 which extends essentially the entire length of the FBHX 14 from the gas and liquid feed inlets 28, 30 to the multi-phase outlet 32.

The fluidizable mixture flow path is in fluid isolation from the heat transfer medium flow path. However, the external sides of the walls of the middle segments 224 of the riser tubes 220 are in fluid contact with the heat transfer medium flow path at the interface between the riser tubes 220 and the interstitial space 240. The upper chamber 216 is an essentially open head space or freeboard from which the multi-phase outlet 32 exits the FBHX 14 through the shell 218.

Operation of the FBHX 14 is essentially the same for each of the separation stages 12₁, 12₂, 12ₙ. Therefore, the preferred method of operating the FBHX 14 in the first separation stage 12₁ described below applies likewise to the remaining separation stages 12₂ and 12ₙ. Referring to FIGS. 1 and 2, the method is initiated by introducing a gas mixture feed from the gas mixture feed source 68 into the lower chamber 212 of the FBHX 14 via the gas mixture feed line 78 and gas feed inlet 28. A liquid feed in the form of a recycled slurry concentrator liquid is simultaneously introduced into the lower chamber 212 of the FBHX 14 from the slurry concentrator 20 via the liquid outlet 48, liquid recycle line 60 and liquid feed inlet 30. Additional liquid feed in the form of a make-up liquid may also be introduced into the lower chamber 212 from the make-up liquid source 70 as desired in a manner described below.

The gas mixture feed is preferably at a gas inlet temperature higher than the maximum hydrate stability temperature of the gas mixture feed at the selected gas inlet pressure. The liquid feed is likewise preferably at a liquid inlet temperature at or just above the maximum hydrate stability temperature of the gas mixture feed at the selected liquid inlet pressure. The liquid feed is generally characterized as an aqueous composition, i.e., a water-containing composition, which is in the liquid phase at the liquid inlet temperature. Examples of a liquid feed having utility herein include fresh water or brine.

The gas mixture feed is generally characterized as a mixture of at least two gas components both of which are in the gas phase at the gas inlet temperature. The first gas component of the gas mixture feed is characterized as a lighter gas component and the second gas component is characterized as a heavier gas component. At least one, and typically both, of the gas components is also capable of forming a stable gas hydrate in the presence of water under certain pressure and temperature conditions. The first and second gas components are each characterized as having a distinct pure component hydrate pressure-temperature (P-T) stability envelope which is different from that of the other.

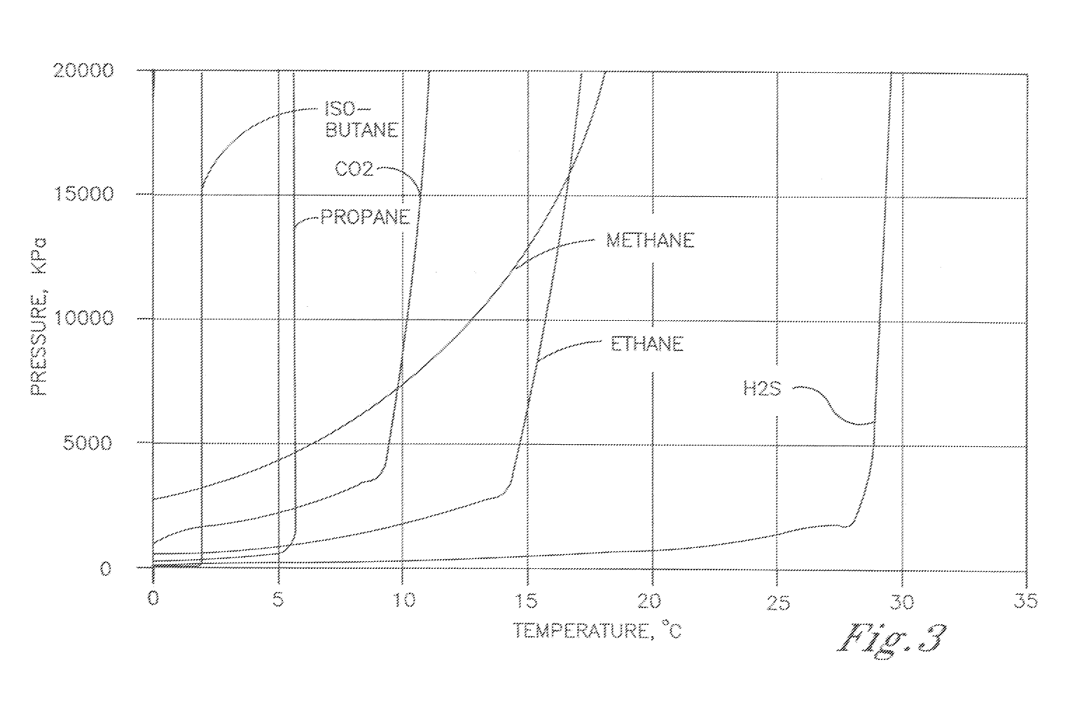

The hydrate P-T stability envelope for a given gas component is a specific loci of pressure and temperature values defining an area on a P-T plot within which the formation of a stable gas hydrate for the given gas component occurs. The boundary limit of this area on the P-T plot is typically defined by a distinct curve as shown in FIGS. 3-5 described below. As such, the hydrate P-T stability envelope for the given gas component is the area above and to the left of the curve. It is noted that when the curves defining the boundary limits of the hydrate P-T stability envelopes for two or more distinct pure components are plotted on a single multi-component hydrate stability graph, portions of the various pure component hydrate P-T stability envelopes may partially overlap or may lie entirely within the hydrate stability envelope of another component.

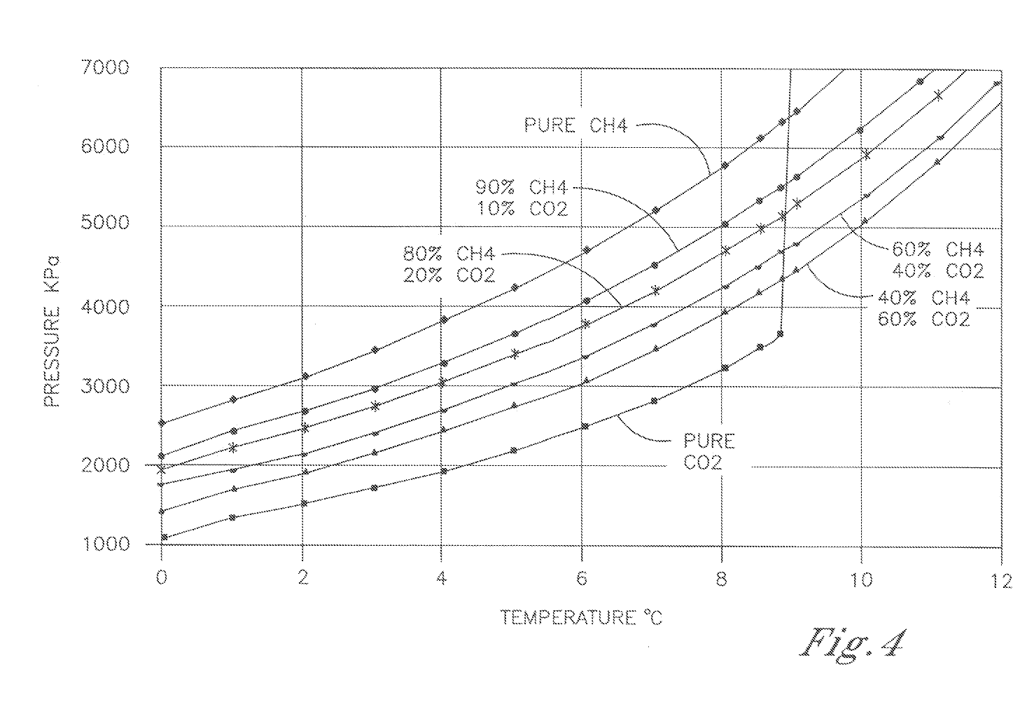

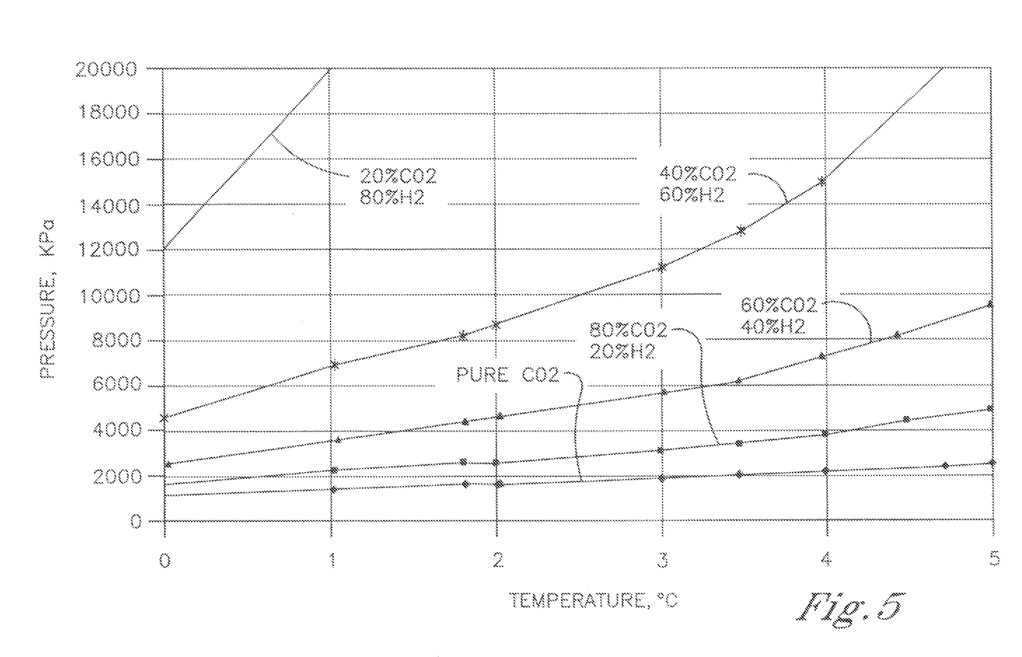

FIG. 3 illustrates an example of a multi-component hydrate stability graph showing the pure component hydrate P-T stability envelopes of several common hydrate-forming gas components, namely, methane, ethane, propane, isobutene, hydrogen sulfide and carbon dioxide. FIG. 4 illustrates an example of a multi-component hydrate stability graph showing the pure component hydrate P-T stability envelopes of pure methane, pure carbon dioxide and several binary mixtures of pure methane and carbon dioxide. FIG. 5 illustrates an example of a multi-component hydrate stability graph showing the pure component hydrate P-T stability envelopes of pure carbon dioxide and several binary mixtures of pure carbon dioxide and hydrogen.

An exemplary lighter gas component capable of forming a stable gas hydrate in accordance with the present process under commonly practical pressure and temperature conditions is methane, nitrogen, oxygen, or carbon monoxide. The present process may also encompass a lighter gas component such as hydrogen which is not generally capable of forming a gas hydrate (with the possible exception of under extremely high pressure conditions). An exemplary heavier gas component capable of forming a stable gas hydrate in accordance with the present process under commonly practical pressure and temperature conditions is carbon dioxide, hydrogen sulfide, ethane, propane or butanes.

In any case, the gas mixture feed and liquid feed form a two-phase fluidizable mixture which is conveyed upward from the open space of the lower chamber 212 through the openings 230 in the lower ends 222 of the riser tubes 220 into the tube interiors 228 as shown by inlet flow arrows 245. The fluidizable mixture has a fluidizable mixture inlet temperature as it enters the lower ends 222 of the riser tubes 220 which is correlated to the gas and liquid inlet temperatures and the relative flows and respective heat capacities thereof. A typical range of the fluidizable mixture inlet temperature between about 2 and 30° C.

A solid scouring medium 246 resides in the tube interiors 228 which is preferably sized larger than the openings 230 in the lower and upper ends 222, 226 of the riser tubes 220 to prevent the scouring medium from exiting the tube interiors 228 and retain the scouring medium 246 in the tube interiors 228. The scouring medium 246 comprises a plurality of divided particles preferably formed from a substantially inert, hard, abrasive material, such as chopped metal wire, gravel, or beads formed from glass, ceramic or metal.

The superficial velocity of the fluidizable mixture entering the lower ends 222 of the riser tubes 220 is such that the upward-flowing fluidizable mixture entrains the solid scouring medium 246 therein to form a fluidized bed comprising a three-phase fluidized mixture. The fluid feed streams, i.e., the gas mixture and liquid feeds, constitute a two-phase fluidizing medium of the fluidized bed and the entrained scouring medium 246 constitutes the solid phase of the fluidized bed. The upward superficial velocity of the fluidizing medium in the riser tubes 220 is typically in a range between about 10 and 90 cm/sec depending primarily on the gas-to-liquid ratio of the fluidized bed and the density of the scouring medium 246 selected.

As the fluidizing medium passes upward through the middle segments 224 of the riser tubes 220 within the middle chamber 214, a heat transfer medium is simultaneously conveyed into the interstitial space 240 in the upper portion 242 of the middle chamber 214 via the heat transfer medium inlet 24. The heat transfer medium is initially at a relatively low heat transfer medium inlet temperature substantially lower than the fluidizable mixture inlet temperature and also lower than the maximum hydrate stability temperature for the gas mixture feed at the operating pressure of the FBHX 14. The heat transfer medium can be essentially any conventional coolant or refrigerant and is preferably a liquid selected from among water, glycol-water mixtures, mineral oil, or other conventional commercially available heat transfer coolants or refrigerants. Such heat transfer media are defined herein as an external heat transfer medium because the heat transfer medium is maintained exclusively within the heat transfer medium flow path and does not enter any of the product flow paths shown in FIG. 1.

The heat transfer medium passes downward through the interstitial space 240 of the middle chamber 214 while maintaining continuous contact with the external sides of the walls of the middle segments 224 of the riser tubes 220 during its descent. The fluidized bed simultaneously maintains continuous contact with the internal sides of the walls of the middle segments 224 of the riser tubes 220. The riser tubes 220 are formed from a heat conductive material, which provides an effective heat transfer surface for the heat transfer medium and fluidized bed. As a result, the fluidized bed is cooled as the fluidizing medium ascends through the middle chamber 214, thereby decreasing the temperature of the fluidized bed. The heat transfer medium is simultaneously heated during its descent through the middle chamber 214, thereby increasing the temperature of the heat transfer medium.

It is noted that the heat transfer coefficients at the internal sides of the walls of the middle segments 224 of the riser tubes 220 are typically very high so that the heat transfer coefficient at the external sides of the walls of the middle segments 224 of the riser tubes 220 becomes the overall limiting resistance to heat transfer between the fluidized bed and the heat transfer medium. Therefore, it is often advantageous to mount fins on the external sides of the walls of the middle segments 224 of riser tubes 220, position baffle plates in the interstitial space 240, or employ other common means to enhance the heat transfer coefficient at the external sides of the walls of the middle segments 224 of the riser tubes 220.

The fluidized bed is cooled as the result of heat transfer between the fluidized bed and the heat transfer medium to a hydrate-forming operating temperature at the operating pressure of the FBHX 14. The hydrate-forming operating temperature is characterized as being less than the gas inlet temperature and the fluidizable mixture inlet temperature. The hydrate-forming operating temperature is further characterized as being outside a pure component hydrate P-T stability envelope of either the lighter gas component or the heavier gas component (but not both), while being inside the hydrate P-T stability envelope of the gas mixture feed at the operating pressure of the FBHX 14.

The temperature difference between the maximum hydrate stability temperature for the specific gas mixture feed and the heat transfer medium inlet temperature is termed the “subcooling temperature difference.” The subcooling temperature difference represents a measure of the driving force for the rate of hydrate formation insofar as the kinetics of hydrate crystal growth rate are a function of the subcooling temperature difference once initial hydrate crystal nucleation occurs. The FBHX 14 of the present embodiment typically operates with a subcooling temperature difference in a range between about 1 and 3° C. The hydrate crystal growth rate may also be limited by the mass transfer rate of the hydrate-forming gas component in the gas mixture feed from the gas phase to the solid hydrate phase. However, the FBHX 14 exhibits a high degree of turbulence caused by the scouring medium 246, which substantially accelerates heat transfer and mass transfer rates in the FBHX 14 relative to a conventional tubular heat exchanger.

In one embodiment of the present process, the hydrate-forming operating temperature of the FBHX 14 is outside the pure component hydrate P-T stability envelope of the lighter gas component, while being inside both the pure component hydrate P-T stability envelope of the heavier gas component and the hydrate P-T stability envelope of the gas mixture feed as a whole at the operating pressure of the FBHX 14. In an alternate embodiment, the hydrate-forming operating temperature of the FBHX 14 is outside the pure component hydrate P-T stability envelope of the heavier gas component while being inside both the pure component hydrate P-T stability envelope of the lighter gas component and the hydrate P-T stability envelope of the gas mixture feed as a whole at the operating pressure of the FBHX 14. A typical hydrate-forming operating temperature of the FBHX 14 (i.e., the temperature to which the fluidized bed is cooled) is in a range between about 0 and 25° C. and more preferably in a range between about 1 and 15° C. A typical operating pressure of the FBHX 14 is in a range between about 100 and 35,000 kPa and more preferably in a range between about 1,000 and 20,000 kPa.

The consequence of cooling the fluidized bed to the hydrate-forming operating temperature as the fluidizing medium ascends through the middle chamber 214 of the FBHX 14 is the formation of a solid gas hydrate in the fluidized bed while the heat transfer medium effectively removes the latent heat of hydrate formation. In particular, gas hydrate formation occurs when at least a fraction of the gas component in the gas mixture feed (termed the hydrate-forming gas component) is cooled to a temperature inside the hydrate P-T stability envelope of the gas mixture feed and contacts at least a fraction of the aqueous composition in the liquid feed at the operating pressure and temperature of the FBHX 14. The resulting reaction forms a plurality of unconsolidated solid gas hydrate particles 248 within the tube interiors 228 in the middle chamber 214 of the FBHX 14 which are entrained in the fluidizing medium as it ascends through the middle segments 224 of the riser tubes 220.

The momentum and viscous drag of the upward flowing fluidizing medium flowing past the scouring medium 246 of the fluidized bed causes the scouring medium 246 to experience an upward force which approximately balances the net downward force of gravity upon the denser particles of the scouring medium 246. The resulting fluidized bed is termed an “expanded bed”. The scouring medium 246 exhibits turbulent flow in the expanded bed which causes the scouring medium 246 to collide with the internal sides of the walls of the riser tubes 220 and with the solid gas hydrate particles 248. The collisions produce a scouring action which diminishes the ability of the solid gas hydrate particles 248 to accumulate on the internal sides of the walls and displaces any solid gas hydrate particles 248 which adhere thereto. Thus, the scouring medium 246 substantially prevents or reduces fouling or plugging of the tube interiors 228 caused by the build-up of solid gas hydrate particles 248.

The collisions also control the ultimate size of the solid gas hydrate particles 248, forming a statistical distribution of particle sizes that are essentially all smaller than an upper particle size limit. The conditions in the expanded bed are selected such that the upper particle size limit of the solid gas hydrate particles 248 is essentially smaller than the size of the openings 230 in the upper ends 226 of the riser tubes 220. Therefore, solid gas hydrate particles 248 having a sufficient superficial velocity at the upper ends 226 of the riser tubes 220 are readily able to exit the tube interiors 228 via the openings 230. The solid gas hydrate particles 248 typically have a crystalline structure within a very small controlled size distribution range with a preferred upper size limit of about 0.1 to 1.0 mm which renders the solid gas hydrate particles 248 smaller than the openings 230 and relatively benign, i.e., resistant to agglomeration.

At least a substantial fraction of the solid gas hydrate particles 248 as well as any remaining unreacted gases and liquids in the two-phase fluidizing medium exit the perforated upper ends 226 of the riser tubes 220 and enter the upper chamber 216 of the FBHX 14 as shown by flow arrows 249 which causes the fluidized bed to disperse. As a result, any of the more dense scouring medium 246 which happens to reach the upper ends 226 of the riser tubes 220 falls downward by gravity, thereby separating the scouring medium 246 from the less dense solid gas hydrate particles 248 and the remaining fluid components of the fluidizing medium. Furthermore, the openings 230 are sized smaller than the particles of the scouring medium 246 to substantially prevent any possible carryover of the scouring medium 246 due to any excessive fluctuations of flow or pressure in the FBHX 14. Thus, essentially all of the scouring medium 246 is retained within the tube interiors 228 of the riser tubes 220 during practice of the present process.

As noted above, the superficial velocity of the fluidizing medium is selected such that the scouring medium 246 is agitated within the expanded fluidized bed in a turbulent fashion, but has essentially no net upward velocity on average. It is further noted that the superficial velocity of the fluidizing medium is preferably maintained at a value large enough to insure that the height of the expanded bed is equal to or greater than the combined length of the lower ends 222 and middle segments 224 of each of the riser tubes 220, thereby avoiding the buildup of solid gas hydrate particles 248 on the internal sides of the walls of the riser tubes 220. The length of the upper ends 226 of the riser tubes 220 should be sufficient to allow the height of the expanded bed to fluctuate slightly due to small changes in flow without causing the fluidized bed to stack up in the upper ends 226 of the riser tubes 220.

The solid gas hydrate particles 248 exiting the upper ends 226 of the riser tubes 220 are suspended in the remaining fluid components of the two-phase fluidizing medium to form a dilute FBHX slurry which enters the open head space of the upper chamber 216. The dilute FBHX slurry is alternately termed a multi-phase mixture and preferably consists of three phases, i.e., a solid, gas, and liquid phase. The solid phase includes the gas hydrate formed from the reaction between the hydrate-forming gas component and the aqueous composition. The gas phase includes any unreacted fraction of the hydrate-forming gas component from the gas mixture feed which remains unreacted for any reason after gas hydrate formation. The gas phase also includes the non-hydrate-forming gas component from the gas mixture feed which is substantially unreacted during gas hydrate formation because the conditions in the FBHX 14 are outside the hydrate P-T stability envelope of that particular gas component. It is apparent that the solid phase gas hydrate is substantially enriched with the hydrate-forming gas component from the gas mixture feed relative to the gas phase because the hydrate-forming gas component from the gas mixture feed is preferentially converted to the solid phase by gas hydrate formation relative to the non-hydrate-forming gas component from the gas mixture feed which is outside its hydrate P-T stability envelope.

The liquid phase includes any aqueous composition not in the solid phase, i.e., any fraction of the aqueous composition from the liquid feed which is unreacted during formation of the gas hydrate. The aqueous composition of the liquid phase in the multi-phase mixture is termed the remaining aqueous composition.

With continuing reference to FIGS. 1 and 2, the multi-phase mixture is withdrawn from the FBHX 14 via the multi-phase outlet 32 and conveyed to the gas separator 16 via the multi-phase inlet 34. The gas separator 16 separates the multi-phase mixture into two separator outlet streams, i.e., a separator slurry and a separator gas. The separator gas is essentially the entirety of the gas phase from the multi-phase mixture and the separator slurry is essentially the entirety of the solid and liquid phases from the multi-phase mixture.

The separator slurry is withdrawn from the gas separator 16 via the slurry outlet 34 and conveyed to the slurry concentrator 20 via the slurry outlet 38 and slurry inlet 44. The slurry concentrator 20 separates a portion of the liquid phase from the separator slurry to produce a concentrated slurry, termed the gas hydrate slurry, and a concentrator liquid, termed the liquid fraction. In accordance with one embodiment, the gas hydrate slurry includes essentially all of the solid phase from the multi-phase mixture and the remaining portion of the liquid phase from the multi-phase mixture not separated out into the liquid fraction. As such, the solid phase is suspended in the liquid phase of the gas hydrate slurry. The liquid fraction of this embodiment is essentially free of solid gas hydrate particles.

In accordance with an alternate embodiment, the gas hydrate slurry includes most, but not all, of the solid phase from the multi-phase mixture suspended in the remaining portion of the liquid phase from the multi-phase mixture not separated out into the liquid fraction. The solid phase of the gas hydrate slurry consists primarily of non-agglomerating larger hydrate particles from the solid phase of the multi-phase mixture. The remaining solid phase of the multi-phase mixture which is not included in the gas hydrate slurry consists essentially of the smaller hydrate particles, typically in a crystalline form. The smaller hydrate particles desirably remain in the liquid fraction which is recycled to the FBHX 14 in a manner described below. The smaller hydrate particles beneficially serve as seeds which nucleate larger crystal growth within the FBHX 14.

In any case, the gas hydrate slurry is withdrawn from the slurry concentrator 20 via the slurry outlet 46 under the control of the slurry flow control valve 66. The slurry pump 74 conveys the gas hydrate slurry to the hydrate decomposer 76 via the hydrate collection line 82. The liquid fraction, which optionally contains smaller gas hydrate particles, is withdrawn from the slurry concentrator 20 via the liquid outlet 48 and recycled to the liquid feed inlet 30 of the FBHX 14 of the first separation stage 12₁ via the liquid recycle line 60 after being repressurized by the liquid pressurizer 22.

The separator gas is withdrawn from the gas separator 16 via the gas outlet 36. The balance of the separator gas is recycled by the gas recycler 18 to the FBHX 14 of the first separation stage 12₁ via the gas recycle line 54, gas mixture feed line 78, and gas feed inlet 28. The remainder of the separator gas not recycled to the FBHX 14 of the first separation stage 12₁ is conveyed under the control of the gas flow control valve 58 to the FBHX 14 of the second separation stage 12₂ via the gas outlet line 56₁ and the gas feed inlet 28. This gas remainder serves as the gas mixture feed to the FBHX 14 of the second separation stage 12₂.

The gas mixture feed to the gas feed inlet 28 of the FBHX 14 for each succeeding separation stage 12ₙ is the remainder gas in the gas outlet line 56ₙ₋₁ of each respective preceding separation stage 12ₙ₋₁. The remainder gas discharged from the gas outlet 36 of the gas separator 16 in the final separation stage 12ₙ, which is termed the purified gas product, is conveyed under the control of the gas flow control valve 58 to the purified gas product receiver 72 via the gas outlet line 56ₙ where the purified gas product is stored and/or subsequently distributed.

The heat transfer medium passes through the heat transfer medium flow path in the FBHX 14 until it reaches the heat transfer medium outlet 26 where the heated heat transfer medium is discharged from the FBHX 14. The heat transfer medium is at a relatively high heat transfer medium outlet temperature, which nevertheless still maintains the subcooling temperature difference and is still lower than the maximum hydrate stability temperature at the temperature and pressure conditions within the FBHX 14.

In accordance with one embodiment, the discharged heated heat transfer medium is conveyed in a continuous loop (not shown) to a conventional external chiller system or refrigeration system where the heated heat transfer medium is cooled back to the low heat transfer medium inlet temperature before reintroducing the cooled heat transfer medium to the FBHX 14 via the heat transfer medium inlet 24. In accordance with an alternate embodiment, the cooled heat transfer medium is only utilized for a single pass through the FBHX 14 and is not subjected any artificial cooling operation. The cooled heat transfer medium of this embodiment is preferably sea water or fresh water having a relatively low ambient temperature and residing in a large body of water proximal to the separation system 10. The cooled heat transfer medium for the FBHX 14 is simply drawn from the body of water as needed and the heated heat transfer medium is discharged from the FBHX 14 back to the body of water which functions as a heat sink.

As noted above, the source of the liquid feed to the liquid feed inlet 30 in the FBHX 14 of each separation stage 12₁, 12₂, 12ₙ is the liquid fraction withdrawn from the slurry concentrator 20 of the same separation stage. However, since at least a portion of the aqueous composition in the liquid feed of each separation stage is consumed during formation of the solid gas hydrate particles 248 and an additional portion of the liquid feed is retained in the gas hydrate slurry withdrawn from the slurry concentrator 20, it is generally necessary to supplement the recycled separator liquid with a make-up liquid. The make-up liquid is drawn from the make-up liquid source 70 via the make-up liquid line 80 and the make-up liquid inlet 62 of each separation stage 12₁, 12₂, 12ₙ. The make-up liquid is discharged under the control of the liquid flow control valve 64 into the FBHX 14 via the liquid recycle line 60 and liquid feed inlet 30.

As further noted above, the gas hydrate slurry withdrawn from the slurry concentrator 20 of each separation stage 12₁, 12₂, 12ₙ is conveyed by the slurry pump 74 to the hydrate decomposer 76 which is preferably a conventional heat exchanger. In certain circumstances it may be advantageous to pressurize the gas hydrate slurry by means of the slurry pump 74 to a higher pressure than the operating pressure of the separation stages. Exemplary slurry pumps suitable for the present process include progressive cavity pumps, gear pumps, centrifugal pumps or other the like. In any case, the gas hydrate slurry is heated in the hydrate decomposer 76 to a temperature slightly above the minimum hydrate stability temperature at the operating pressure of the hydrate decomposer 76 in order to decompose the gas hydrate and form a system discharge mixture which is discharged from the hydrate decomposer 76 via the system discharge outlet 84.

The system discharge mixture comprises a substantial fraction of the hydrate-forming gas component from the gas mixture feed. This fraction is termed the system discharge gas. The system discharge mixture further comprises essentially the entirety of the liquid make-up fed to each separation stage 12₁, 12₂, 12ₙ. This liquid is termed the system discharge liquid. Preferably all, or at least a substantial fraction, of the system discharge mixture is in the liquid phase. Accordingly, all, or at least a substantial fraction, of the system discharge gas in the system discharge mixture is dissolved in the system discharge liquid so that the presence of a free gas in the system discharge mixture is minimized or essentially eliminated. The resulting system discharge mixture can be disposed or further utilized as deemed appropriate by the skilled practitioner. Exemplary disposal of the system discharge mixture includes injection into a saline aquifer or a petroleum reservoir.

The gas mixture feed has been specifically characterized for purposes of illustration in the above-recited embodiment as a mixture of only two gas components, wherein the first gas component is a lighter gas component and the second gas component is a heavier gas component. It is understood that the present process is likewise applicable to a gas mixture feed having three or more gas components, wherein one of the gas components is a first gas component and the remaining two or more gas components define a gas component mixture. The first gas component is preferably a relatively lighter gas component and the gas component mixture is preferably relatively heavier than the first gas component. The first gas component has a distinct pure component hydrate P-T stability envelope which is different from the component mixture hydrate P-T stability envelope of the gas component mixture, except in the case where the first gas component is a non-hydrate-forming gas such as hydrogen.

Separation of the first gas component from the gas component mixture combined in the gas mixture feed is effected by introducing the gas mixture feed and a liquid feed to one or more serial FBHX's and cooling the gas mixture feed and liquid feed in the same manner as recited above to a desired temperature at a desired pressure, wherein the desired pressure and temperature are outside the pure component hydrate P-T stability envelope of the first gas component, but are inside the component mixture hydrate P-T stability envelope of the gas component mixture. The gas component mixture reacts with the aqueous composition to form a gas hydrate while the first gas component preferably remains in the free gas phase. As a result, the system discharge mixture comprises a substantial fraction of the heavier gas components in the gas component mixture of the gas mixture feed and the purified gas product comprises a substantial fraction of the first gas component of the gas mixture feed and is substantially depleted of the heavier gas components in the gas component mixture of the gas mixture feed.

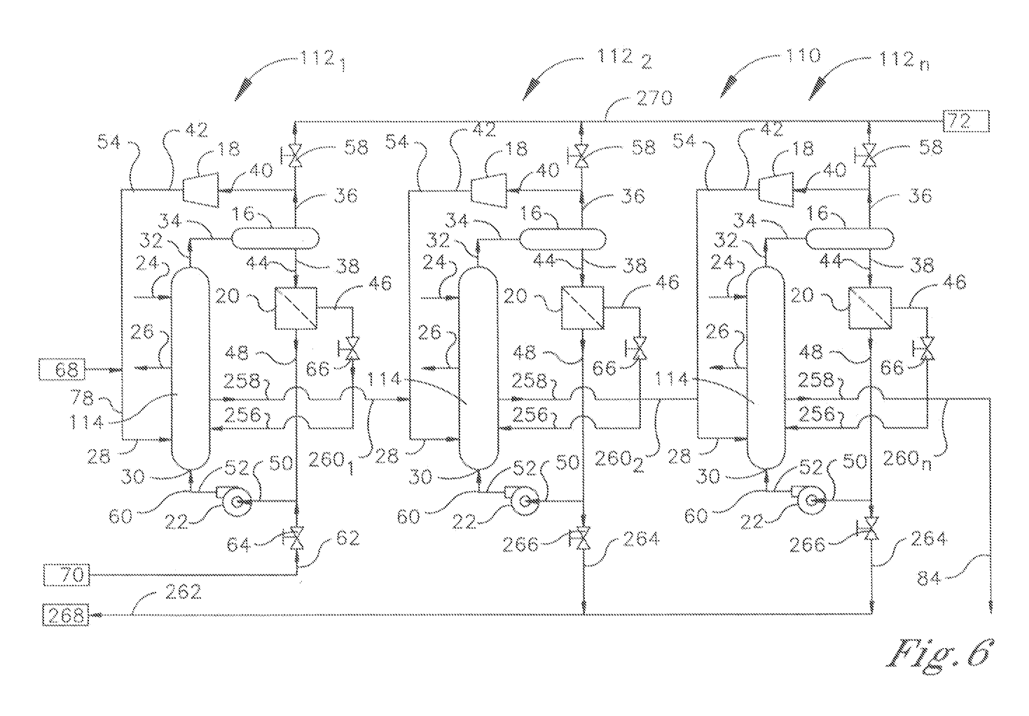

Referring to FIG. 6, a schematic flow diagram of an alternate separation system generally designated 110 is shown, which has utility in the practice of an alternate embodiment of the gas separation process of the present invention. The separation system 110 has many elements which are the same or similar to those of the separation system 10. Accordingly, the description below of the separation system 110 focuses on those elements which differ from those of the separation system 10. Elements which are common to the separation systems 10 and 110 are designated by the same reference numbers. Furthermore, since the separation system 110 includes a plurality of essentially identical sequential separation stages 112₁, 112₂, 112ₙ operating in series, the elements of the separation stages 112₁, 112₂, 112ₙ are described below with reference to a single common separation stage 112.

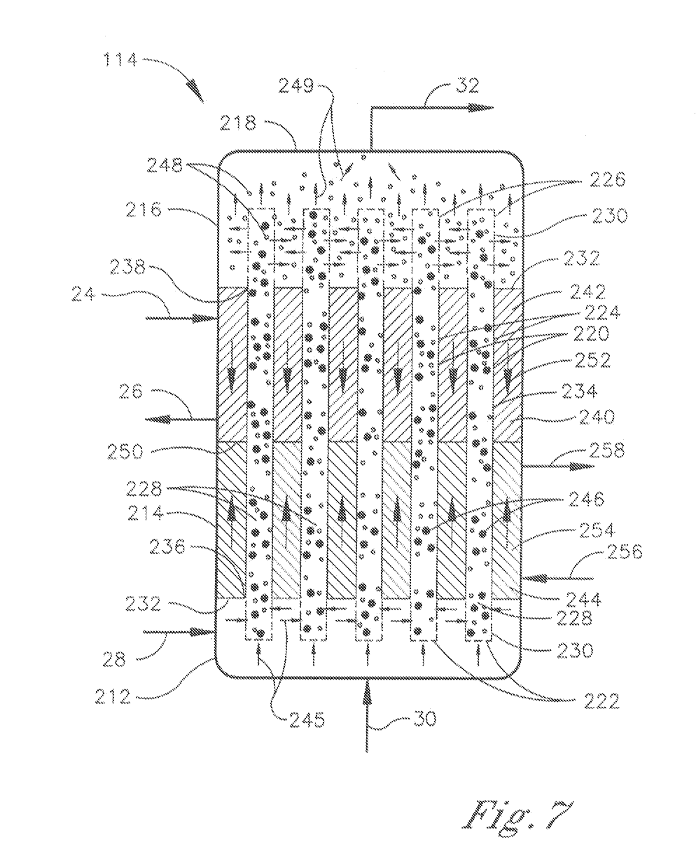

The separation stage 112 has a hydrate-forming heat exchanger, which is preferably an FBHX 114, shown and described with additional reference to FIG. 7. The FBHX 114 includes the lower chamber 212 defining the mixing zone, the middle chamber 214 defining the heat transfer zone, and the upper chamber 216 defining the separation zone. The gas feed inlet 28 and the liquid feed inlet 30 access the lower chamber 212 and the multi-phase outlet 32 exits the upper chamber 216. The riser tubes 220 are vertically disposed and spatially separated from one another within the middle chamber 214 to provide an interstitial space 240 between and around the riser tubes 220. A divider plate 250 is horizontally disposed across the interstitial space 240 of the middle chamber 214 to essentially bisect the interstitial space 240 into an upper interstitial space 252 and a lower interstitial space 254, which are fluid isolated from one another by means of the divider plate 250. It is noted, however, that the divider plate 250 does not penetrate or otherwise block the riser tubes 220 to impede flow therethrough.

The heat transfer medium inlet 24 accesses the upper interstitial space 252 in the upper portion 242 of the middle chamber 214 and the heat transfer medium outlet 26 accesses the upper interstitial space 252 below the heat transfer medium inlet 24 more proximal to, but still above, the divider plate 250 in the upper portion 242 of the middle chamber 214. The heat transfer medium inlet 24, upper interstitial space 252, and heat transfer medium outlet 26 in combination define the heat transfer medium flow path through the FBHX 114, which extends essentially only the length of the upper portion 242 of the middle chamber 214.

The FBHX 114 also includes a slurry inlet 256 and a discharge outlet 258. The slurry inlet 256 accesses the lower interstitial space 254 in the lower portion 244 of the middle chamber 214. The slurry inlet 256 is coupled to the slurry outlet 46 of the slurry concentrator 20 under the control of the slurry flow control valve 66 shown in FIG. 6. The discharge outlet 258 accesses the lower interstitial space 254 above the slurry inlet 256 more proximal to, but still below, the divider plate 250 in the lower portion 244 of the middle chamber 214. The slurry inlet 256, lower interstitial space 254, and discharge outlet 258 in combination define a gas hydrate slurry flow path through the FBHX 114, which extends essentially only the length of the lower portion 244 of the middle chamber 214.

The discharge outlet 258 is coupled to one end of a discharge mixture line 260 shown in FIG. 6. The opposite end of the discharge mixture line 260 is coupled to the gas feed inlet 28 of the succeeding separation stage, thereby providing communication between the preceding and succeeding separation stages. Accordingly, the discharge mixture in the discharge mixture line 260₁, 260ₙ₋₁ from each preceding separation stage 112₁, 112ₙ₋₁ is included in the feed to the gas feed inlet 28 of the FBHX 114 in each succeeding separation stage 112₂, 112ₙ, respectively. The feed to the gas feed inlet 28 of each separation stage 112₁, 112₂, 112ₙ further includes the separator gas in the gas recycle line 54 from the same separation stage. The gas feed inlet 28 of the first separation stage 112₁, but not the remaining separation stages 112₂, 112ₙ, also draws fresh gas feed mixture from the gas mixture feed source 68 via the gas mixture feed line 78. It is further noted that the discharge mixture in the discharge mixture line 260ₙ from the final separation stage 12ₙ, which is termed the system discharge mixture, is conveyed directly from the discharge outlet 258 to the system discharge outlet 84, rather than to the gas feed inlet 28 of another separation stage.

The liquid feed to the liquid feed inlet 30 of each separation stage 112₁, 112₂, 112ₙ is the recycled concentrator liquid received via the liquid recycle line 60 from the liquid outlet 48 of the slurry concentrator 20 in the same separation stage. The liquid feed to the liquid feed inlet 30 of the first separation stage 112₁, but not the remaining separation stages 112₂, 112ₙ, also draws fresh make-up liquid as desired from the make-up liquid source 70 via the make-up liquid inlet 62 under the control of the liquid flow control valve 64. The remaining separation stages 112₂, 112ₙ are coupled in parallel by a liquid collection line 262. The liquid collection line 262 collects excess concentrator liquid from the remaining separation stages 112₂, 112ₙ via respective excess liquid outlets 264 coupled to the liquid outlets 48 of the slurry concentrators 20 under the control of excess liquid flow control valves 266. The outlet end of the liquid collection line 262 is further coupled to an excess liquid receiver 268, thereby providing a conduit from the remaining separation stages 112₂, 112ₙ to the excess liquid receiver 268.

The alternate configuration of the separation system 110 obviates the need for a hydrate decomposer and substantially reduces the cooling requirements for the heat transfer medium relative to the separation system 10 as is apparent from a preferred method of operating the FBHX 114 described below. Operation of the FBHX 114 is similar to operation of the FBHX 14, but with distinctions as noted below.

Operation of the FBHX 114 is initiated by introducing the gas mixture feed characterized above into the lower chamber 212 via the gas feed inlet 28. The liquid feed characterized above is simultaneously introduced into the lower chamber 212 via the liquid feed inlet 30. The gas mixture feed and liquid feed constitute the fluidizing medium which is conveyed upward through the tube interiors 228 in the lower portion 244 of the middle chamber 214 of the FBHX 114. The gas hydrate slurry is simultaneously withdrawn from the slurry concentrator 20 via the slurry outlet 46, partially depressurized, introduced into the FBHX 114 via the slurry inlet 256, and co-currently conveyed through the lower interstitial space 254. The ascending gas hydrate slurry promotes cooling and gas hydrate formation in the fluidized bed by absorbing the latent heat of hydrate formation from the ascending fluidizing medium. The gas hydrate slurry is termed an internal heat transfer medium because it is obtained from the product flow path and performs a cooling function. The latent heat of hydrate formation absorbed by the ascending gas hydrate slurry also heats the gas hydrate particles 248 therein and decomposes them to form a discharge mixture which is withdrawn from the FBHX 114 via the discharge outlet 258. The discharge mixture comprises a gas phase and liquid phase and is substantially enriched in the heavier gas component, but may also include a significant fraction of the lighter gas component.

The ascending fluidizing medium continues upward through the tube interiors 228 in the upper portion 242 of the middle chamber 214 where the fluidized bed is further cooled by the heat transfer medium which is counter-currently conveyed through the upper interstitial space 252. The heat transfer medium promotes the growth of existing gas hydrate particles and produces new gas hydrate particles 248 in the fluidized bed.

Upon withdrawal of the discharge mixture from the discharge outlet 258 of the preceding separation stage, it is conveyed to the succeeding separation stage via the discharge mixture line 260 which is coupled to the gas feed line 28 of the succeeding separation stage. The discharge mixture is recovered from the discharge outlet 258 in the final separation stage 112ₙ of the separation system 110 and is conveyed to the system discharge outlet 84.

A gas collection line 270 collects the purified gas product from each separation stage 112₁, 112₂, 112ₙ via the respective gas outlets 36 of the gas separators 16 for recovery at the purified gas product receiver 72. The flow of purified gas product from each separation stage 112₁, 112₂, 112ₙ is under the control of the gas flow control valve 58 which enables the practitioner to maintain each separation stage 112 at a desired specified operating pressure.

The operating pressure and temperature of each succeeding separation stage of the separation system 110 are at a pressure and temperature which are lower than those of the preceding separation stage. Although the gas mixture feed in each succeeding separation stage is more enriched with the heavier gas component, the solid gas hydrate formed in each succeeding separation stage, nevertheless, recovers a substantial fraction of the heavier gas component. However, a smaller fraction of the lighter component is recovered in the solid gas hydrate formed in each succeeding separation stage due to the decreased pressure. Thus, greater quantities of the lighter gas component are recovered in the purified gas product using the separation system 110 than using the separation system 10.

Both separation systems 10 and 110 have utility for separating a heavier gas component from a lighter gas component in a gas mixture feed by forming a solid gas hydrate from the heavier gas component and added water while maintaining the lighter gas component as a purified gas product. However, the separation system 10 has particular utility when the gas mixture feed has a high fraction of the heavier gas component relative to the lighter gas component and it is desirable to recover a large fraction of the heavier gas component in the solid gas hydrate while maintaining the purified gas product at a relatively high pressure which is close to the gas inlet pressure of the system 10. By comparison, the separation system 110 has particular utility when it is desirable to recover a large fraction of the lighter gas component from the gas mixture feed in the purified gas product. However, the trade-off is that the purified gas product from the separation system 110 is undesirably recovered at a reduced pressure significantly lower than the gas inlet pressure of the system 110.

The following examples demonstrate the practice and utility of the present invention, but are not to be construed as limiting the scope thereof.

### EXAMPLE 1

A gas mixture feed consists of nearly equal amounts by volume of methane and carbon dioxide. The gas mixture feed contains 50 mole % methane and 50 mole % carbon dioxide. It is desired to separate the gas feed mixture into a purified gas product which retains a large fraction of the methane and a system discharge mixture which retains a large fraction of the carbon dioxide and a minimal fraction of the methane. The gas mixture feed is fed to an FBHX in a first separation stage of a three-stage separation system of the type shown in FIG. 6. Water is also fed to the FBHX of the first separation stage which includes make-up water at a ratio of 40 moles water per mole of carbon dioxide. The gas inlet temperature to the FBHX is 25° C. and the operating pressure of the FBHX is 3500 kPa.

The FBHX cools the gas and liquid feeds including recycle streams to a temperature of 3.5° C., which causes 92% of the carbon dioxide and 51% of the methane in the gas mixture feed to form a solid gas hydrate in association with the feed water. The residual portions of the methane and carbon dioxide, i.e., 49% of the methane feed and 8% of the carbon dioxide feed, remain a free gas mixture. The solid gas hydrate, free gas mixture and water are withdrawn from the FBHX and the free gas mixture is separated from them in a gas separator of the first separation stage. A purified gas is recovered from the gas separator at a rate of 29% by volume of the gas mixture feed rate to the first separation stage. The balance of the purified gas is recycled to the FBHX of the first separation stage. The rate of gas recycle to the FBHX is selected to create an interfacial area between the dispersed vapor phase and the continuous liquid phase in the FBHX which optimizes mass transfer without excessively reducing the density of the fluidizing medium which influences its ability to fluidize of the scouring media. The remaining purified gas not recycled to the FBHX of the first separation stage is conveyed to the purified gas product receiver.

A gas hydrate slurry containing 26% by weight of solids is recovered from a slurry concentrator of the first separation stage. The remaining liquid fraction not in the gas hydrate slurry is recycled to the FBHX of the first separation stage at a rate sufficient to insure fluidization of the scouring medium and an expanded bed height extending over the entire length of the tube interiors. The gas hydrate slurry is depressurized to 2600 kPa and decomposed in the FBHX of the first separation stage. The resulting discharge mixture is recovered from the FBHX of the first separation stage and fed to the FBHX of the second separation stage which is operating at 2600 kPa.

The FBHX of the second separation stage is at an operating temperature of 0.8° C., which reincorporates 88% of the carbon dioxide and 30% of the methane fed to the FBHX of the second separation stage into the solid gas hydrate phase in association with a portion of the feed water. The residual portions of the methane and carbon dioxide, i.e., 70% of the methane feed and 12% of the carbon dioxide feed, remain a free gas mixture. The solid gas hydrate, free gas mixture and water are withdrawn from the FBHX and the free gas mixture is separated from them in the gas separator of the second separation stage. A purified gas is recovered from the gas separator at a rate of 68% by volume of the gas mixture feed rate to the second separation stage. The balance of the purified gas is recycled to the FBHX of the second separation stage at the selected rate. The remaining purified gas not recycled to the FBHX of the second separation stage is conveyed to the purified gas product receiver.

A gas hydrate slurry containing 19% by weight of solids is recovered from the slurry concentrator of the second separation stage. The remaining liquid fraction not in the gas hydrate slurry is recycled to the FBHX of the second separation stage at the selected rate. The gas hydrate slurry is depressurized to 2000 kPa and decomposed in the FBHX of the second separation stage. The resulting discharge mixture is recovered from the FBHX of the second separation stage and fed to the FBHX of the third separation stage which is operating at 2000 kPa.

The FBHX of the third separation stage is at an operating temperature of 0° C., which reincorporates 92% of the carbon dioxide and 34% of the methane fed to the FBHX of the third separation stage into the solid gas hydrate phase in association with a portion of the feed water. The residual portions of the methane and carbon dioxide, i.e., 66% of the methane feed and 8% of the carbon dioxide feed, remain a free gas mixture. The solid gas hydrate, free gas mixture and water are withdrawn from the FBHX and the free gas mixture is separated from them in the gas separator of the third separation stage. A purified gas is recovered from the gas separator at a rate of 17% by volume of the gas mixture feed rate to the third separation stage. The balance of the purified gas is recycled to the FBHX of the third separation stage at the selected rate. The remaining purified gas not recycled to the FBHX of the third separation stage is conveyed to the purified gas product receiver.

A gas hydrate slurry containing 16% by weight of solids is recovered from the slurry concentrator of the third separation stage. The remaining liquid fraction not in the gas hydrate slurry is recycled to the FBHX of the third separation stage at the selected rate. The gas hydrate slurry is decomposed in the FBHX of the third separation stage. The resulting discharge mixture is recovered from the FBHX as the system discharge mixture and conveyed to the system discharge outlet. The combined purified gas product collected from the first, second and third separation stages contains 95% of the methane in the original gas mixture feed and only 25% of the carbon dioxide. The system discharge mixture from the third separation stage contains 75% of the carbon dioxide from the original gas mixture feed and only 5% of the methane.

### EXAMPLE 2

A gas mixture feed consists of a low concentration of methane and a high concentration of carbon dioxide. The gas mixture feed contains 20 mole % methane and 80 mole % carbon dioxide. It is desired to separate the gas feed mixture into a purified gas product which retains a minimal fraction of carbon dioxide and a system discharge mixture which retains a large fraction of carbon dioxide. The gas mixture feed is fed to an FBHX in a first separation stage of a three-stage separation system of the type shown in FIG. 1. Water is also fed to the FBHX of the first separation stage which includes make-up water at a ratio of 35 moles water per mole of carbon dioxide. The gas inlet temperature is 25° C. and the operating pressure of the first stage FBHX is 2800 kPa.

The FBHX cools the gas and liquid feeds including recycle streams to a temperature of 3.2° C., which causes 87% of the carbon dioxide and 27% of the methane in the gas mixture feed to form a solid gas hydrate in association with the feed water. The residual portions of the methane and carbon dioxide, i.e., 73% of the methane feed and 13% of the carbon dioxide feed, remain a free gas mixture. The solid gas hydrate, free gas mixture and water are withdrawn from the FBHX and the free gas mixture is separated from them in a gas separator of the first separation stage. A purified gas is recovered from the gas separator at a rate of 25% by volume of the gas mixture feed rate to the first separation stage. The balance of the purified gas is recycled to the FBHX of the first separation stage. The rate of gas recycle to the FBHX is selected to create an interfacial area between the dispersed vapor phase and the continuous liquid phase in the FBHX which optimizes mass transfer without excessively reducing the density of the fluidizing medium which influences its ability to fluidize of the scouring media.

A gas hydrate slurry containing 21% by weight of solids is recovered from a slurry concentrator of the first separation stage and conveyed to a hydrate collection line. The remaining liquid fraction not in the gas hydrate slurry is recycled to the FBHX of the first separation stage at a rate sufficient to insure fluidization of the scouring medium and an expanded bed height extending over the entire length of the tube interiors.

The remaining purified gas not recycled to the FBHX of the first separation stage is fed to the FBHX of the second separation stage which is operating at 2700 kPa. Make-up water is also fed to the FBHX of the second separation stage at a ratio of 24 moles water per mole of carbon dioxide in the gas mixture feed. The FBHX is at an operating temperature of 1.9° C., which converts 60% of the carbon dioxide and 7% of the methane fed to the FBHX of the second separation stage into solid gas hydrate in association with a portion of the feed water. The residual portions of the methane and carbon dioxide, i.e., 93% of the methane feed and 40% of the carbon dioxide feed, remain a free gas mixture. The solid gas hydrate, free gas mixture and water are withdrawn from the FBHX and the free gas mixture is separated from them in the gas separator of the second separation stage. A purified gas is recovered from the gas separator at a rate of 71% by volume of the gas mixture feed rate to the second separation stage. The balance of the purified gas is recycled to the FBHX of the second separation stage at the selected rate.

A gas hydrate slurry containing 22% by weight of solids is recovered from the slurry concentrator of the second separation stage and conveyed to the hydrate collection line. The remaining liquid fraction not in the gas hydrate slurry is recycled to the FBHX of the second separation stage at the selected rate.

The remaining purified gas not recycled to the FBHX of the second separation stage is fed to the FBHX of the third separation stage which is operating at 2600 kPa. Make-up water is also fed to the FBHX of the third separation stage at a ratio of 23 moles water per mole of carbon dioxide in the gas mixture feed. The FBHX is at an operating temperature of 0.8° C., which converts 56% of the carbon dioxide and 9% of the methane fed to the FBHX of the third separation stage into solid gas hydrate in association with a portion of the feed water. The residual portions of the methane and carbon dioxide, i.e., 91% of the methane feed and 44% of the carbon dioxide feed, remain a free gas mixture. The solid gas hydrate, free gas mixture and water are withdrawn from the FBHX and the free gas mixture is separated from them in the gas separator of the third separation stage. A purified gas is recovered from the gas separator at a rate of 80% by volume of the gas mixture feed rate to the third separation stage. The balance of the purified gas is recycled to the FBHX of the third separation stage at the selected rate.

A gas hydrate slurry containing 28% by weight of solids is recovered from the slurry concentrator of the third separation stage and conveyed to the hydrate collection line. The remaining liquid fraction not in the gas hydrate slurry is recycled to the FBHX of the third separation stage at the selected rate. The remaining purified gas from the third separation stage not recycled to the FBHX of the third separation stage is conveyed to the purified gas product receiver as the purified gas product. The purified gas product contains 62% of the methane from the original gas mixture feed and only 2% of the carbon dioxide.

The combined gas hydrate slurry collected in the hydrate collection line from the first, second and third separation stages contains 98% of the carbon dioxide in the original gas mixture feed and only 38% of the methane. The combined gas hydrate slurry is conveyed to a hydrate decomposer and heated slightly to near ambient temperature which decomposes the solid gas hydrate in the slurry forming a system discharge mixture. Substantially all of the carbon dioxide from the solid gas hydrate is dissolved in the liquid phase of the system discharge mixture.

### EXAMPLE 3

High-purity hydrogen is a desirable fuel source for emerging technologies such as fuel cells. High-purity hydrogen also has significant utility in the petrochemical and oil refining industries. Furthermore, environmental concern over global climate stability and carbon dioxide emissions advances the desirability of capturing and sequestering carbon dioxide. Hydrogen is commercially produced in a synthesis gas, which is a mixture of hydrogen, carbon monoxide, and other gas by-products, using various reforming and gasification technologies. For example, synthesis gas is produced by steam-reforming a hydrocarbon gas, such as conventional natural gas or a gas obtained from liquid petroleum, from gasification of solid carbonaceous fuels such as coal or petroleum coke, or from renewable resources such as biomass using oxygen steam or air. A certain amount of carbon dioxide is produced during the steam-reforming or gasification process as well as during follow-up processes which maximize the hydrogen production. For example, reacting the carbon monoxide of a synthesis gas with steam to produce additional hydrogen via a water-gas-shift reaction also produces additional carbon dioxide.

The complexity, cost and energy requirements for producing high-purity hydrogen from synthesis gas containing substantial quantities of carbon dioxide, residual carbon monoxide and other gases is a significant fraction of the overall delivered cost for high-purity hydrogen. Conventional prior art methods for producing high-purity hydrogen involve removing carbon dioxide from the synthesis gas using semi-permeable membranes, regenerated solvent recovery processes, and/or pressure-swing adsorption. These separation processes generally result in the recovery of hydrogen and/or carbon dioxide at low pressures, which necessitates costly recompression.

Gases having molecular diameters less than ˜3.7 Angstroms, such as hydrogen, do not stabilize or form gas hydrates or, at best, only form gas hydrates under extreme pressures. The larger molecular diameter and heavier gases such as carbon dioxide, carbon monoxide, nitrogen, methane and others readily form gas hydrates under commercially practical pressure and temperature conditions. Therefore, the present process is particularly suited to separation of high-purity hydrogen from other heavier gases such as carbon dioxide at high pressure, while simultaneously allowing the capture of carbon dioxide in a water solution which is suitable for injection into a brine aquifer or petroleum reservoir.

Process of the present example is initiated by introducing a gas mixture feed to an FBHX in a separation system similar to that shown in FIG. 1, but having only one separation stage. The gas mixture feed is derived from a water-gas-shifted synthesis gas produced by an oxygen-blown gasifier operating on a solid carbonaceous feedstock. The gas feed mixture consists of hydrogen, carbon dioxide and a small residual amount of carbon monoxide and the mixture is saturated with water vapor at the gas feed conditions. The specific gas feed mixture composition is 47 mole % hydrogen, 48 mole % carbon dioxide, and 5 mole % carbon monoxide on a dry basis. A liquid feed consisting of water is introduced to the FBHX at a ratio of 30 moles water per mole of carbon dioxide in the gas mixture feed.

The FBHX cools the gas and liquid feeds including recycle streams to a temperature slightly above 0° C., which causes 74% of the carbon dioxide and carbon monoxide in the gas mixture feed to form a solid gas hydrate in association with the feed water. Essentially all of the hydrogen remains a free gas mixture. The solid gas hydrate, free gas mixture and water are withdrawn from the FBHX and the hydrogen is separated from them in a gas separator and recovered as a purified gas product at a rate of 61% by volume of the gas mixture feed rate. The balance of the purified gas product is recycled to the FBHX. The rate of gas recycle to the FBHX is selected to create an interfacial area between the dispersed vapor phase and the continuous liquid phase in the FBHX which optimizes mass transfer without excessively reducing the density of the fluidizing medium which influences its ability to fluidize of the scouring media.

A gas hydrate slurry containing 21% by weight of solids is recovered from a slurry concentrator and conveyed to a hydrate decomposer. The remaining liquid fraction not in the gas hydrate slurry is recycled to the FBHX at a rate sufficient to insure fluidization of the scouring medium and an expanded bed height extending over the entire length of the tube interiors. The gas hydrate slurry is heated slightly in the hydrate decomposer to near ambient temperature which decomposes the solid gas hydrate in the slurry forming a system discharge mixture. The discharge mixture contains 40 moles of water per mole of carbon dioxide.

Substantially all of the carbon dioxide remains dissolved in the liquid phase of the discharge mixture with only a small portion of gas, consisting primarily of carbon monoxide and a trace of carbon dioxide, present in the gas phase of the discharge mixture. The gas phase is readily separated from the liquid phase. The dissolved carbon dioxide is likewise readily separated from the liquid phase, if desired, by heating or pressure reduction. However, it is advantageous to retain the dissolved carbon dioxide in solution when disposing the discharge mixture into a disposal well which is drilled into a suitable subterranean formation because the power requirements for pumping a relatively incompressible fluid are substantially reduced relative to the power requirements for compressing a compressible gas. Furthermore, the hydrostatic gradient of a dense fluid down a wellbore reduces the surface pressure required for injection into the disposal well.

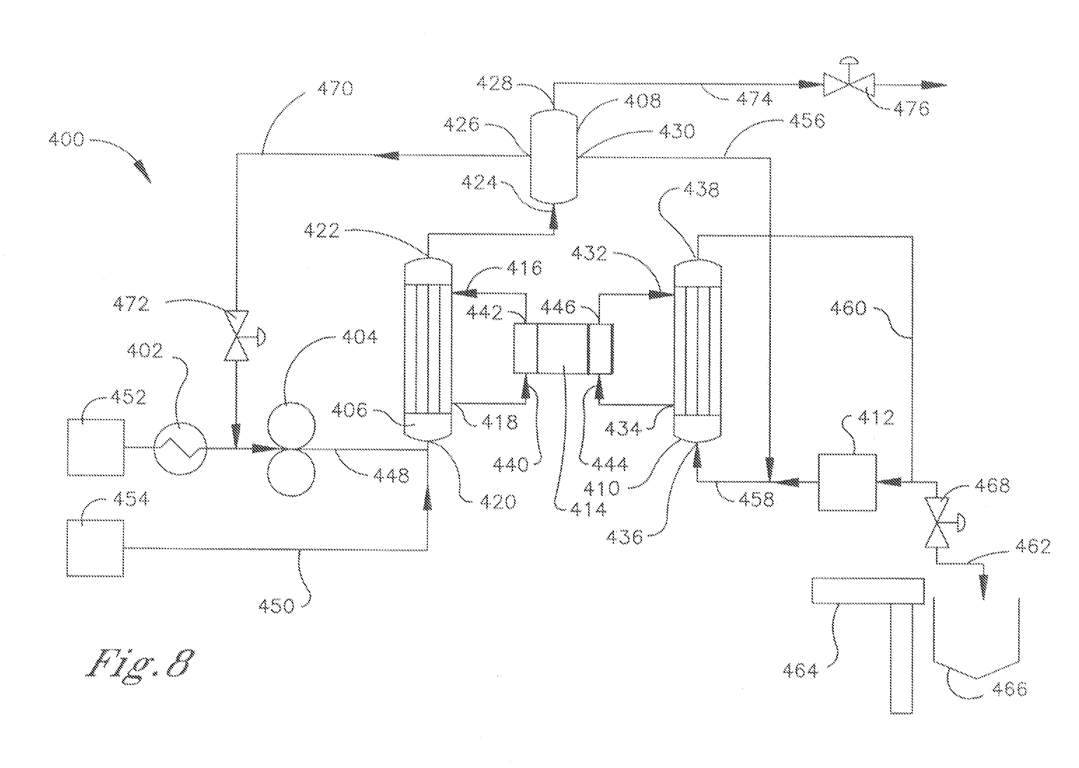

An alternate characterization of the present invention as a gas transportation process is described below. Referring to FIG. 8, a schematic flow diagram of a gas hydrate slurry formation system generally designated 400 is shown, which has utility at a gas loading terminal in the practice of the gas transportation process of the present invention. The gas hydrate slurry formation system 400 includes an inlet cooler 402, a multi-phase pump 404, a hydrate-forming heat exchanger 406, a multi-phase separator 408, a slurry subcooling heat exchanger 410, a slurry recirculation pump 412, and a dual refrigeration system 414. The hydrate-forming heat exchanger 406 and slurry subcooling heat exchanger 410 are each configured substantially the same as the FBHX 14 shown and described above with reference to FIG. 2. It is understood, however, that the FBHX's 406, 410 are shown by way of example rather than by way of limitation and that other alternately configured FBHX's can be adapted by the skilled artisan for utility herein such as the FBHX 114 of FIG. 7.

The hydrate-forming heat exchanger 406 has a cool heat transfer medium inlet 416, a cool heat transfer medium outlet 418, a fluid feed inlet 420, and a multi-phase outlet 422. The multi-phase separator 408 has a multi-phase inlet 424, a recycle outlet 426, a residual gas outlet 428, and a slurry subcooling outlet 430. The subcooling heat exchanger 410 has a cold heat transfer medium inlet 432, a cold heat transfer medium outlet 434, a slurry recirculation inlet 436, and a slurry outlet 438. The dual refrigeration system 414 has a higher-temperature duty side which includes a cool heat transfer medium inlet 440 coupled to the cool heat transfer medium outlet 418 of the FBHX 406 and a cool heat transfer medium outlet 442 coupled to the cool heat transfer medium inlet 416 of the FBHX 406. The dual refrigeration system 414 has a corresponding lower-temperature duty side which includes a cold heat transfer medium inlet 444 coupled to the cold heat transfer medium outlet 434 of the FBHX 410 and a cold heat transfer medium outlet 446 coupled to the cold heat transfer medium inlet 432 of the FBHX 410.

The fluid feed inlet 420 of the FBHX 406 is coupled to a hydrocarbon fluid feed line 448 and an aqueous fluid feed line 450. The opposite end of the hydrocarbon fluid feed line 448 is coupled to a hydrocarbon fluid feed source 452. The opposite end of the aqueous fluid feed line 450 is coupled to an aqueous fluid feed source 454. The inlet cooler 402 and multi-phase pump 404 are serially positioned in-line in the hydrocarbon fluid feed line 448. The slurry subcooling outlet 430 of the multi-phase separator 408 is coupled to a slurry subcooling line 456. The slurry recirculation pump 412 is positioned in-line in a slurry recirculation line 458 and the opposite end of the slurry subcooling line 456 is coupled to the slurry recirculation line 458 downstream of the slurry recirculation pump 412 and upstream of the slurry recirculation inlet 436.

The slurry outlet 438 of the FBHX 410 is coupled to a slurry outlet line 460 and the opposite end of the slurry outlet line 460 splits into the slurry recirculation line 458 and a slurry loading line 462. The slurry loading line 462 is coupled to a slurry loading dock 464 which accommodates a slurry transporter 466. A slurry flow control valve 468 is positioned in the slurry loading line 462. The recycle outlet 426 of the multi-phase separator 408 is coupled to a recycle line 470. The opposite end of the recycle line 470 ties into the hydrocarbon fluid feed line 448 downstream of the inlet cooler 402 and upstream of the multi-phase pump 404. A recycle flow control valve 472 is positioned in the recycle line 468. The residual gas outlet 428 of the multi-phase separator 408 is coupled to a gas outlet line 474. A gas flow control valve 476 is positioned in the gas outlet line 470.

Operation of the hydrate slurry formation system 400 is initiated by conveying a hydrocarbon fluid feed from the hydrocarbon fluid feed source 452 to the inlet cooler 402 via the hydrocarbon fluid feed line 448. The hydrocarbon fluid feed is a fluid mixture of a hydrocarbon liquid, such as a crude oil or a natural gas condensate, and a hydrocarbon gas. The hydrocarbon gas may be a single pure component, such as methane, which is capable of forming a solid gas hydrate when reacted with water under specified practical pressure and temperature operating conditions of the FBHX 406. However, the hydrocarbon gas is more typically a mixture of multiple components, such as a natural gas, at least one of which is capable of forming a solid gas hydrate when reacted with water under specified practical pressure and temperature operating conditions of the FBHX 406. Thus, a wet gas, such as a natural gas, is an example of a mixture of a hydrocarbon liquid and a hydrocarbon gas which can function as the hydrocarbon fluid feed in the present process.

The hydrocarbon fluid feed is pre-cooled in the inlet cooler 402 to an inlet temperature which preferably approximates the ambient air or water temperature, but is not at or below the maximum hydrate stability temperature of the hydrocarbon fluid feed at the selected inlet pressure. The pre-cooled hydrocarbon fluid feed is conveyed from the inlet cooler 402 to the multi-phase pump 404 via the hydrocarbon fluid feed line 424 where it is pressurized to an inlet pressure in a range between about 2200 and 10,500 kPa and preferably between about 6300 and 7700 kPa. The resulting hydrocarbon fluid feed is conveyed to the fluid feed inlet 420 of the FBHX 406.

An aqueous fluid feed, which contains water, is simultaneously conveyed to the fluid feed inlet 420 of the FBHX 406 from the aqueous fluid feed source 454 via the aqueous fluid feed line 450. The aqueous fluid feed and hydrocarbon fluid feed are simultaneously introduced to the bottom of the FBHX 406 via the fluid feed inlet 420 where the hydrocarbon and aqueous fluid feeds mix to form a two-phase fluidizing medium. The relative feed rates of the hydrocarbon fluid feed and aqueous fluid feed to the FBHX 406 are preferably selected so that the weight ratio of water to gas in the resulting fluidizing medium is in a range between about 4 and 8 depending on the composition of the hydrocarbon gas in the hydrocarbon fluid feed.

The FBHX 406 operates in substantially the same manner as described above with respect to the FBHX 14. The FBHX 406 cools the fluidizing mixture to a hydrate-forming operating temperature by means of the cool heat transfer medium which is circulated through the cool heat transfer medium flow path in the FBHX 406 extending from the cool heat transfer medium inlet 416 to the cool heat transfer medium outlet 418. The hydrate-forming operating temperature is below the maximum hydrate stability temperature of the fluidizing medium at the operating pressure of the FBHX 406. The hydrate-forming operating temperature of the FBHX 406 is typically below about 10° C. at the operating pressure of the FBHX 406. Thus, at least a portion of the hydrate-forming component in the hydrocarbon gas reacts with at least a portion of the water in the aqueous feed of the fluidizing medium at the conditions of the FBHX 406 to form a plurality of solid gas hydrate particles.

The solid gas hydrate particles are suspended in the remaining fluid components of the two-phase fluidizing medium to form a dilute FBHX slurry which is alternately termed a multi-phase mixture. The multi-phase mixture preferably consists of three phases, i.e., a solid phase, a liquid phase and a gas phase. The solid phase includes the gas hydrate formed from the reaction between the hydrate-forming gas component and water. The gas phase includes any portion of the hydrate-forming gas component from the hydrocarbon fluid feed which remains unreacted for any reason after gas hydrate formation. The gas phase also includes any non-hydrate-forming gas components from the hydrocarbon fluid feed which are substantially unreacted during gas hydrate formation because the conditions in the FBHX 406 are outside the hydrate P-T stability envelope of that particular gas component. It is apparent that the solid gas hydrate is substantially enriched with the hydrate-forming gas component from the hydrocarbon fluid feed relative to the gas phase because the hydrate-forming gas component from the hydrocarbon fluid feed is preferentially converted to the solid gas hydrate relative to the non-hydrate-forming gas component from the hydrocarbon fluid feed which is outside its hydrate P-T stability envelope.

The liquid phase includes any aqueous fluid feed not in the solid phase, i.e., any fraction of the aqueous fluid feed which is unreacted during formation of the gas hydrate. The fraction of the aqueous fluid feed in the liquid phase of the multi-phase mixture is termed the remaining aqueous composition. The liquid phase also includes the hydrocarbon liquid in the hydrocarbon fluid feed.

The multi-phase mixture is withdrawn from the FBHX 406 via the multi-phase outlet 422 and conveyed to the multi-phase separator 408 via the multi-phase inlet 424. The multi-phase separator 408 separates the multi-phase mixture. The multi-phase mixture is preferably separated into two separator outlet streams, i.e., a gas hydrate slurry and a multi-phase recycle. The multi-phase recycle is essentially the entirety of the gas phase from the multi-phase mixture and essentially the entirety, or at least the balance, of the portion of the aqueous fluid feed in the liquid phase of the multi-phase mixture. The multi-phase recycle may also include a portion of the hydrocarbon liquid from the multi-phase mixture.

Alternatively, the multi-phase separator 408 separates the multi-phase mixture into three separator outlet streams, i.e., the gas hydrate slurry, the multi-phase recycle, and a residual gas. The multi-phase recycle is essentially the same as described above except that it does not include the entirety of the gas phase from the multi-phase mixture. The residual gas contains a portion of the hydrate-forming and non-hydrate-forming gas components from the hydrocarbon fluid feed which remain unreacted after gas hydrate formation.

In either case, the gas hydrate slurry includes a portion or all of the solid gas hydrate particles and a portion of the hydrocarbon liquid, wherein the solid gas hydrate particles are suspended in the hydrocarbon liquid. In accordance with one embodiment, the gas hydrate slurry includes essentially all of the solid phase from the multi-phase mixture and the remaining portion of the liquid phase from the multi-phase mixture not separated out into the multi-phase recycle. As such, the multi-phase recycle of this embodiment is essentially free of solid gas hydrate particles.

In accordance with an alternate embodiment, the gas hydrate slurry includes most, but not all, of the solid phase from the multi-phase mixture and the remaining portion of the liquid phase from the multi-phase mixture not separated out into the multi-phase recycle. The solid phase of the gas hydrate slurry consists primarily of non-agglomerating larger hydrate particles from the solid phase of the multi-phase mixture. The remaining solid phase of the multi-phase mixture which is not included in the gas hydrate slurry consists essentially of the smaller hydrate particles, typically in a crystalline form. The smaller hydrate particles desirably remain in the multi-phase recycle which is recycled to the FBHX 406 in a manner described below. The smaller hydrate particles beneficially serve as seeds which nucleate larger crystal growth within the FBHX 406.

The multi-phase recycle is withdrawn from the multi-phase separator 408 via the recycle outlet 426 and recycled to the hydrocarbon fluid feed line 448 via the recycle line 470 under the control of the recycle flow control valve 472. The multi-phase recycle mixes with the hydrocarbon fluid feed in the hydrocarbon fluid feed line 448 and is repressurized in the multi-phase pump 404 before being recycled to the FBHX 406 with the hydrocarbon fluid feed via the fluid feed inlet 420.

The residual gas, if any, is withdrawn from the multi-phase separator 408 via the residual gas outlet 428 and gas outlet line 480. The gas flow control valve 476 prevents system pressure from rising above a maximum predetermined value by venting the residual gas from the hydrate slurry formation system 400.

The gas hydrate slurry is conveyed from the multi-phase separator 408 via the slurry sub-cooling outlet 430 and slurry sub-cooling line 456 to the slurry recirculation line 458. The gas hydrate slurry is fed to the FBHX 410 via the slurry recirculation line 458 and slurry recirculation inlet 436. The FBHX 410 subcools the gas hydrate slurry by means of the cold heat transfer medium which is circulated through the cold heat transfer medium flow path in the FBHX 410 extending from the cold heat transfer medium inlet 432 to the cold heat transfer medium outlet 434. The gas hydrate slurry is subcooled in the FBHX 410 to a sub-cooled temperature in range between about −20 and −80° C. Any solid waxes or other solid-forming components which would otherwise accumulate on and foul the heat transfer surfaces of the FBHX 410 at the low-temperature of the FBHX 410 are scoured away and reduced to a non-aggregating form by the action of the scouring medium in the FBHX 410. The resulting subcooled gas hydrate slurry is withdrawn from the FBHX 410 via the slurry outlet 430. A portion of the subcooled gas hydrate slurry is fed to the slurry recirculation pump 412 via the slurry outlet line 460 which recycles the subcooled gas hydrate slurry to the FBHX 410 upon mixing with the gas hydrate slurry from the slurry subcooling line 456. The flow rate of the recycled subcooled gas hydrate slurry recirculated by the slurry recirculation pump 412 is maintained at a value sufficient to fluidize the scouring medium within the FBHX 410.

The remaining portion of the subcooled gas hydrate slurry which is not recycled to the FBHX 410 is conveyed from the slurry outlet line 460 to the slurry loading dock 464 via the slurry loading line 468 under the control of the slurry flow control valve 468. The subcooled gas hydrate slurry depressurized to near-ambient pressure and withdrawn from the system 400 at the slurry loading dock 464. In particular, the depressurized sub-cooled gas hydrate slurry is loaded onto the slurry transporter 466 at the slurry loading line 462. Despite depressurization of the subcooled gas hydrate slurry, the solid gas hydrate particles remain quasi-stable in the slurry due to the sub-cooling step and the fact that decomposition of the gas hydrate particles would require heat supplied by the sensible heat of the slurry itself which would result in further cooling of the slurry. The slurry transporter 466 which is an insulated transportation vessel such as a sea-going tanker ship which preferably transports the gas hydrate slurry to a desired off-loading terminal.

During operation of the hydrate slurry formation system 400, a cool heat transfer medium enters the cool heat transfer medium flow path of the FBHX 406 via the cool heat transfer medium inlet 416, is circulated through the cool heat transfer medium flow path of the FBHX 406 and discharged from the FBHX 406 at the terminus of the cool heat transfer medium flow path via the cool heat transfer medium outlet 418. The discharged cool heat transfer medium is at a relatively high cool heat transfer medium outlet temperature. The discharged heated cool heat transfer medium is conveyed in a continuous loop to the higher-temperature duty side of the dual refrigeration system 414 via the cool heat transfer medium inlet 440. The heated cool heat transfer medium is cooled back to the low cool heat transfer medium inlet temperature in the higher-temperature duty side of the refrigeration system 414 before the cooled cool heat transfer medium is discharged from the refrigeration system 414 via the cool heat transfer medium outlet 442 and reintroduced to the FBHX 406 via the cool heat transfer medium inlet 416.

A cold heat transfer medium similarly enters the cold heat transfer medium flow path of the FBHX 410 via the cold heat transfer medium inlet 432, is circulated through the cold heat transfer medium flow path of the FBHX 410 and discharged from the FBHX 410 at the terminus of the cold heat transfer medium flow path via the cold heat transfer medium outlet 434. The discharged cold heat transfer medium is at a relatively high cold heat transfer medium outlet temperature. The discharged heated cold heat transfer medium is conveyed in a continuous loop to the lower-temperature duty side of the refrigeration system 414 via the cold heat transfer medium inlet 444. The heated cold heat transfer medium is cooled back to the low cold heat transfer medium inlet temperature in the lower-temperature duty side of the refrigeration system 414 before discharging the cooled cold heat transfer medium from the refrigeration system 414 via the cold heat transfer medium outlet 446 and reintroducing the cooled cold heat transfer medium to the FBHX 410 via the cold heat transfer medium inlet 432.

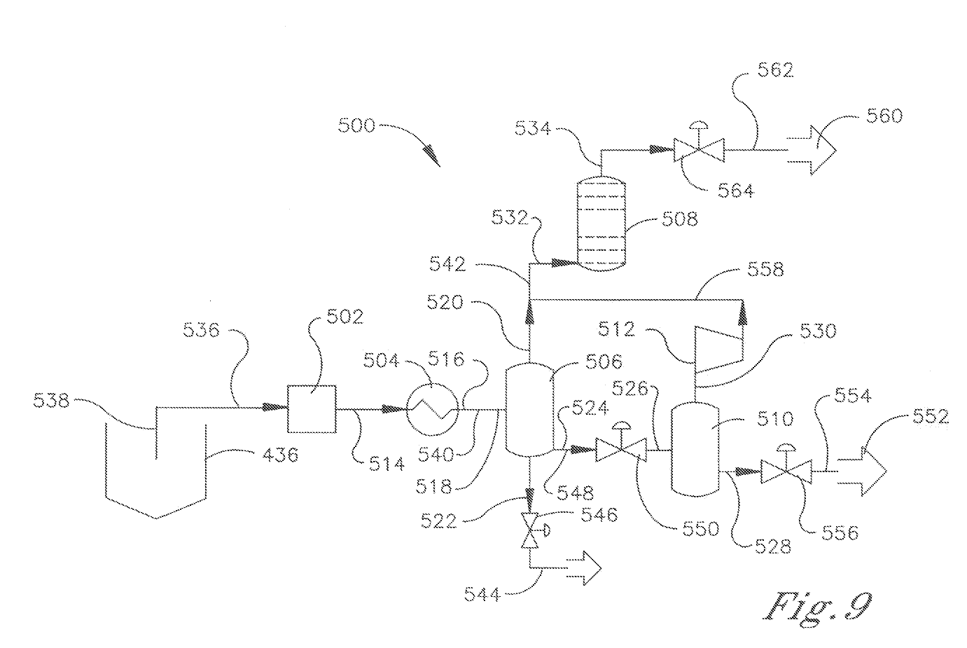

Referring to FIG. 9, a schematic flow diagram of a gas hydrate slurry decomposition system generally designated 500 is shown, which has utility at a gas off-loading terminal in the practice of the gas transportation process of the present invention. The gas hydrate slurry decomposition system 500 includes a slurry pump 502, an inlet heater 504, a high-pressure separator 506, a dehydration unit 508, a low-pressure separator 510, and a compressor 512.

The inlet heater 504 has a slurry inlet 514 and a decomposition mixture outlet 516. The high-pressure separator 506 has a decomposition mixture inlet 518, a hydrocarbon gas outlet 520, an aqueous fluid outlet 522, and a hydrocarbon liquid outlet 524. The low-pressure separator 510 has a hydrocarbon liquid inlet 526, a hydrocarbon liquid product outlet 528, and a hydrocarbon gas outlet 530. The dehydration unit 508 has a hydrocarbon gas inlet 532 and a hydrocarbon gas product outlet 534.

The slurry inlet 514 of the inlet heater 504 is coupled to a slurry off-loading line 536. The opposite end of the slurry off-loading line 536 is coupled to a slurry off-loading dip tube 538 at a slurry off-loading dock which accommodates the slurry transporter 436. The slurry pump 502 is positioned in-line in the slurry off-loading line 536. The decomposition mixture outlet 516 of the inlet heater 504 is coupled to the decomposition mixture inlet 518 of the high-pressure separator 506 via a decomposition mixture line 540. The hydrocarbon gas outlet 520 of the high-pressure separator 506 is coupled to the hydrocarbon gas inlet 532 of the dehydration unit 508 via a hydrocarbon gas line 542. The aqueous fluid outlet 522 of the high-pressure separator 506 is coupled to an aqueous fluid discharge line 544 having an aqueous fluid flow control valve 546 positioned therein.

The hydrocarbon liquid outlet 524 of the high-pressure separator 506 is coupled to the hydrocarbon liquid inlet 526 of the low-pressure separator 510 via a hydrocarbon liquid line 548. A hydrocarbon liquid flow control valve 550 is positioned in the hydrocarbon liquid line 548. The hydrocarbon liquid outlet 528 of the low-pressure separator 510 is coupled to a hydrocarbon liquid product receiver 552 via a hydrocarbon liquid product line 554. A hydrocarbon liquid product flow control valve 556 is positioned in the hydrocarbon liquid product line 554. The hydrocarbon gas outlet 530 of the low-pressure separator 510 is coupled to a hydrocarbon gas return line 558. The opposite end of the hydrocarbon gas return line 558 ties into the hydrocarbon gas line 542. The compressor 512 is positioned in-line in the hydrocarbon gas return line 558. The hydrocarbon gas product outlet 534 of the dehydration unit 508 is coupled to a hydrocarbon gas product receiver 560 via a hydrocarbon gas product line 562. A hydrocarbon gas product flow control valve 564 is positioned in the hydrocarbon gas product line 562.

Operation of the hydrate slurry decomposition system 500 is initiated by off-loading the hydrate gas slurry into the slurry off-loading line 536 from the slurry transporter 436 by means of the slurry off-loading dip tube 538 at the slurry off-loading dock. The characteristics of the off-loaded hydrate gas slurry are substantially as described above with respect to the gas hydrate slurry loaded onto the slurry transporter 436 at the slurry loading dock 434. The off-loaded gas hydrate slurry in the slurry off-loading line 536 is pressurized by the slurry pump 502 to an outlet pressure in a range between about 800 and 10,500 kPa and in no case higher than the operating pressure of a gas pipeline system or other gas distribution system to which the hydrocarbon gas product will ultimately be delivered.

The pressurized gas hydrate slurry is conveyed to the inlet heater 504 via the slurry off-loading line 536 and slurry inlet 514. The inlet heater 504 is a conventional heat exchanger which heats the gas hydrate slurry to a decomposition temperature above the maximum hydrate stability temperature of the solid gas hydrate particles in the gas hydrate slurry at the operating pressure of the inlet heater 504. The inlet heater 504 provides sufficient latent heat to the gas hydrate slurry to decompose (i.e., melt and dissociate) the solid gas hydrate particles therein. The resulting decomposition mixture from the inlet heater 504 includes the hydrocarbon liquid, the hydrocarbon gas and the aqueous fluid in a liquid state.

The decomposition mixture is conveyed from the inlet heater 504 to the high-pressure separator 506 via the decomposition mixture outlet 516, decomposition mixture line 540 and decomposition mixture inlet 518. The hydrocarbon gas, hydrocarbon liquid and aqueous liquid of the decomposition mixture are separated from one another in the high-pressure separator 506. The aqueous liquid is discharged from the bottom of the high-pressure separator 506, typically for disposal, via the aqueous fluid outlet 522 and aqueous fluid discharge line under the control of the aqueous fluid flow control valve 546. The hydrocarbon liquid is conveyed to the low-pressure separator 510 via the hydrocarbon liquid outlet 524, hydrocarbon liquid line 548, and hydrocarbon liquid inlet 526 under the control of the hydrocarbon liquid flow control valve 550.

The hydrocarbon liquid is flashed down to a low pressure in the low pressure separator 510 typically causing the evolution of additional hydrocarbon gases and vapors from the hydrocarbon liquid. The resulting hydrocarbon liquid product is conveyed to the hydrocarbon liquid product receiver 552 via the hydrocarbon liquid product outlet 528 and hydrocarbon liquid product line 554. The hydrocarbon liquid product receiver 552 is preferably a storage vessel, such as a storage tank, where the hydrocarbon liquid product is retained for subsequent use and/or further processing.

The hydrocarbon gas is conveyed as a free gas phase from the high-pressure separator 506 to the dehydration unit 508 via the hydrocarbon gas outlet 520, hydrocarbon gas line 542, and hydrocarbon gas inlet 532. Any additional hydrocarbon gas recovered from the low-pressure separator 510 as a free gas phase is discharged to the compressor 512 via the hydrocarbon gas outlet 530. The additional hydrocarbon gas is repressurized in the compressor 512 to the operating pressure of the high-pressure separator 506 and conveyed to the hydrocarbon gas line 542 via the hydrocarbon gas return line 558 where the additional hydrocarbon gas is mixed with the hydrocarbon gas from the high-pressure separator 506 in the hydrocarbon gas line 542. Alternatively, although not shown, the additional hydrocarbon gas can be recovered from the low-pressure separator and withdrawn from the gas hydrate slurry decomposition system 500 for use as a low-pressure fuel.

The hydrocarbon gas from the high-pressure separator 506 and the hydrocarbon gas from the low-pressure separator 510, if any, is fed to the dehydration unit 508 via the hydrocarbon gas line 542 and hydrocarbon gas inlet 532. The dehydration unit 508 removes any residual water remaining in the hydrocarbon gas to produce a hydrocarbon gas product. The hydrocarbon gas product is delivered to the hydrocarbon gas product receiver 560 via the hydrocarbon gas product outlet 534 and hydrocarbon gas product line 562 under the control of the hydrocarbon gas product flow control valve 564. The hydrocarbon gas product receiver 560 is preferably a gas pipeline system or other gas distribution system.

It is apparent from the operational description of the gas hydrate slurry decomposition system 500 above that the present process substantially reduces costly gas compression requirements for delivering hydrocarbon gas product to a high pressure gas pipeline system or other gas distribution system.

While the forgoing preferred embodiments of the invention have been described and shown, it is understood that alternatives and modifications, such as those suggested and others, may be made thereto and fall within the scope of the invention.

I claim:

1. A gas separation process comprising:
entraining a solid particle medium in a fluidizable mixture to form a fluidized mixture, wherein said fluidizable mixture includes an aqueous liquid feed and a gas mixture feed including a first gas having a first hydrate P-T stability envelope and a second gas having a second hydrate P-T stability envelope different from said first hydrate P-T stability envelope;
conveying said fluidized mixture past a heat transfer surface while contacting said fluidized mixture with said heat transfer surface, wherein said heat transfer surface is cooler than said fluidized mixture;
cooling said fluidized mixture upon contact with said heat transfer surface to an operating temperature at an operating pressure, wherein said operating pressure and operating temperature are outside said first hydrate P-T stability envelope and inside said second hydrate P-T stability envelope;
converting at least a portion of said second gas and at least a portion of said aqueous liquid feed to a plurality of gas hydrate particles;
forming a gas hydrate slurry comprising said plurality of gas hydrate particles and a portion of said aqueous liquid feed; and
separating said gas hydrate slurry from said first gas.

2. The gas separation process of claim 1 further comprising heating said gas hydrate slurry after separating said gas hydrate slurry from said first gas to decompose said gas hydrate particles and produce a decomposition quantity of said second gas and said portion of said aqueous liquid feed.

3. The gas separation process of claim 1 further comprising recovering said first gas separated from said gas hydrate slurry to provide a first recovered quantity of said first gas as a purified gas product.

4. The gas separation process of claim 3, wherein said gas mixture feed is a first gas mixture feed and wherein said first recovered quantity is present in a second gas mixture feed with an unreacted portion of said second gas from said first gas mixture feed, said process further comprising repeating the steps of claim 1 on said second gas mixture feed.

5. The gas separation process of claim 4 further comprising recovering said first gas separated from said gas hydrate slurry in the repeating steps of claim 4 to provide a second recovered quantity of said first gas more concentrated than said first recovered quantity.

6. The gas separation process of claim 5, wherein said second recovered quantity is a purified gas product.

7. The gas separation process of claim 1 further comprising placing said gas hydrate slurry in heat transfer communication with said fluidized mixture to absorb latent heat of hydrate formation.

8. The gas separation process of claim 1 further comprising placing said gas hydrate slurry in heat transfer communication with said fluidized mixture to decompose said gas hydrate particles in said gas hydrate slurry.

9. The gas separation process of claim 1, wherein said solid particle medium is essentially inert in the presence of said fluidizable mixture.

10. A gas separation process comprising:
fluidizing a solid particle medium, water, a first gas having a first hydrate P-T stability envelope and a second gas having a second hydrate P-T stability envelope different from said first hydrate P-T stability envelope to form a fluidized bed comprising said solid particle medium, said water, said first gas and said second gas;
cooling said first gas and said second gas to an operating temperature at an operating pressure, wherein said operating pressure and said operating temperature are outside said first hydrate P-T stability envelope and inside said second hydrate P-T stability envelope;
converting at least a portion of said second gas and at least a portion of said water to gas hydrate particles; and
separating said gas hydrate particles from said first gas.

11. The gas separation process of claim 10 further comprising heating said gas hydrate particles after separating said gas hydrate particles from said first gas to decompose said gas hydrate particles and produce a decomposition quantity of said second gas and said portion of said water.

12. The gas separation process of claim 10 further comprising recovering said first gas separated from said gas hydrate particles to provide a first recovered quantity of said first gas as a purified gas product.

13. The gas separation process of claim 12 further comprising recycling said first recovered quantity to said fluidized bed.

14. The gas separation process of claim 10 further comprising placing said gas hydrate particles in heat transfer communication with said fluidized mixture to absorb latent heat of hydrate formation.

15. The gas separation process of claim 10 further comprising placing said gas hydrate particles in heat transfer communication with said fluidized mixture to decompose said gas hydrate particles.

16. The gas separation process of claim 10, wherein said solid particle medium is essentially inert in the presence of said first gas and said second gas.

17. A gas separation process comprising:
entraining a solid particle medium in a fluidizable mixture to form a fluidized mixture, wherein said fluidizable mixture includes water, a first gas having a first hydrate P-T stability envelope and a second gas having a second hydrate P-T stability envelope different from said first hydrate P-T stability envelope;
conveying said fluidized mixture past a heat transfer surface while contacting said fluidized mixture with said heat transfer surface, wherein said heat transfer surface is cooler than said fluidized mixture;
cooling said fluidized mixture upon contact with said heat transfer surface to an operating temperature at an operating pressure, wherein said operating pressure and operating temperature are outside said first hydrate P-T stability envelope and inside said second hydrate P-T stability envelope;
converting at least a portion of said second gas and at least a portion of said water to gas hydrate particles; and
separating said gas hydrate particles from said first gas.

18. The gas separation process of claim 17 further comprising heating said gas hydrate particles after separating said gas hydrate particles from said first gas to decompose said gas hydrate particles and produce a decomposition quantity of said second gas and said portion of said water.

19. The gas separation process of claim 17 further comprising recovering said first gas separated from said gas hydrate particles to provide a first recovered quantity of said first gas as a purified gas product.

20. The gas separation process of claim 19, wherein said gas mixture feed is a first gas mixture feed and wherein said first recovered quantity is present in a second gas mixture feed with an unreacted portion of said second gas from said first gas mixture feed, said process further comprising repeating the steps of claim 1 on said second gas mixture feed.

21. The gas separation process of claim 20 further comprising recovering said first gas separated from said gas hydrate particles in the repeating steps of claim 1 to provide a second recovered quantity of said first gas more concentrated than said first recovered quantity.

22. The gas separation process of claim 21, wherein said second recovered quantity is a purified gas product.

23. The gas separation process of claim 17 further comprising placing said gas hydrate particles in heat transfer communication with said fluidized mixture to absorb latent heat of hydrate formation.

24. The gas separation process of claim 17 further comprising placing said gas hydrate slurry in heat transfer communication with said fluidized mixture to decompose said gas hydrate particles.

25. The gas separation process of claim 17, wherein said solid particle medium is essentially inert in the presence of said fluidizable mixture.
